(19) United States
(12) Patent Application Publication
(10) Pub. No.: US 2025/0316702 A1
(43) Pub. Date: Oct. 9, 2025

(54) SECONDARY BATTERY AND ELECTRONIC APPARATUS

(71) Applicant: DONGGUAN AMPEREX TECHNOLOGY LIMITED, Dongguan (CN)

(72) Inventors: Xiaoping LIN, Dongguan (CN); Xin LI, Dongguan (CN); Yuansen XIE, Dongguan (CN)

(73) Assignee: DONGGUAN AMPEREX TECHNOLOGY LIMITED, Dongguan (CN)

(21) Appl. No.: 19/003,475

(22) Filed: Dec. 27, 2024

(30) Foreign Application Priority Data
Dec. 29, 2023 (CN) 202311862924.8

(51) Int. Cl. H01M 4/62; H01M 4/02; H01M 4/133; H01M 4/587; H01M 10/0567; H01M 10/058

(52) U.S. Cl. CPC H01M 4/628; H01M 4/133; H01M 4/587; H01M 10/0567; H01M 10/058; H01M 2004/021; H01M 2004/027; H01M 2300/0025

(57) ABSTRACT

A secondary battery includes a positive electrode, a negative electrode, and an electrolyte solution; wherein the negative electrode includes a negative electrode material layer. The negative electrode material layer includes a negative electrode active material and a solid electrolyte material. The solid electrolyte material contains aluminum, titanium, phosphorus. The secondary battery is cycled at an ambient temperature of 25° C., and after going N cycles, the negative electrode material layer comprises Li₂O, Li_{0.5}TiO₂, Li₃P, and Li₃PO₄, wherein 10≤N≤2000. Based on a mass of the negative electrode material layer, a mass percentage of Li₂O is 0.006% to 1.25%, a mass percentage of Li_{0.5}TiO₂ is 0.005% to 2%, a mass percentage of Li₃P is 0.003% to 0.8%, and a mass percentage of Li₃PO₄ is 0.006% to 1.6%.

### CROSS-REFERENCE TO RELATED APPLICATION

The present application claims priority to Chinese Patent application No. CN 202311862924.8 filed in the China National Intellectual Property Administration on Dec. 29, 2023, the entire content of which is hereby incorporated by reference.

### TECHNICAL FIELD

This application relates to the field of electrochemical technologies, and in particular, to a secondary battery and an electronic apparatus.

### BACKGROUND

Lithium-ion batteries have been widely used in the field of portable consumer electronics by virtue of their characteristics such as high specific energy, high working voltage, low self-discharge rate, small size, and light weight. With the rapid development of electric vehicles and mobile electronic devices in recent years, there are increasingly high requirements have been imposed on the cycling performance of lithium-ion batteries.

At present, with the increase of charge rate, the limitation on the migration speed of lithium ions results in an increasing internal polarization of lithium-ion batteries, affecting the rate performance and cycling performance of lithium-ion batteries.

### SUMMARY

An objective of this application is to provide a secondary battery and an electronic apparatus, to lower the impedance of the secondary battery, and improve the rate performance, lithium precipitation performance and cycling performance of the secondary battery. Specific technical solutions are as follows.

It should be noted that in the invention of this application, the lithium-ion battery is used as an example of the secondary battery to illustrate this application. However, the secondary battery of this application is not limited to the lithium-ion battery.

A first aspect of this application provides a secondary battery and an electronic apparatus. The secondary battery includes a positive electrode, a negative electrode, and an electrolyte solution. The negative electrode includes a negative electrode material layer. The negative electrode material layer includes a negative electrode active material and a solid electrolyte material. The solid electrolyte material contains aluminum, titanium, phosphorus. The secondary battery is cycled at an ambient temperature of 25° C., and after going N charge-discharge cycles, the negative electrode material layer comprises Li₂O, Li_{0.5}TiO₂, Li₃P, and Li₃PO₄, wherein 10≤N≤2000, and each of N charge-discharge cycles consisting of charging to 4.45 V at a constant current of 0.02 C, then charging to 0.025 C at a constant voltage of 4.45 V, then leaving standing for 5 minutes, and then discharging to 3.0 V at 0.5 C; and based on a mass of the negative electrode material layer, a mass percentage of Li₂O is 0.006% to 1.25%, a mass percentage of Li_{0.5}TiO₂ is 0.005% to 2%, a mass percentage of Li₃P is 0.003% to 0.8%, and a mass percentage of Li₃PO₄ is 0.006% to 1.6%. With the addition of a solid electrolyte material to the negative electrode material layer, the solid electrolyte material is capable of reacting in situ to generate products Li₂O, Li_{0.5}TiO₂, Li₃P, and Li₃PO₄. When the cycled products Li₂O, Li_{0.5}TiO₂, Li₃P, and Li₃PO₄ are controlled within the ranges in this application, as electron/ion conductors, Li₂O, Li_{0.5}TiO₂, Li₃P, and Li₃PO₄ can enhance the ionic conductance of the negative electrode while balancing the electronic conductance of the negative electrode and improve the lithium precipitation performance while lowering the impedance of the secondary battery, thereby enhancing the rate performance and cycling performance of the secondary battery. In addition, the solid electrolyte material added can reduce contact between the negative electrode active material and the electrolyte solution, thereby reducing side reactions between the electrolyte solution and the negative electrode active material, and work synergistically with the cycled products Li₂O, Li_{0.5} TiO₂, Li₃P, and Li₃PO₄ to further improve the lithium precipitation performance of the secondary battery and enhance the cycling performance of the secondary battery. Therefore, the secondary battery has good rate performance, lithium precipitation performance, and cycling performance.

In an embodiment of this application, based on the mass of the negative electrode material layer, a mass percentage of the solid electrolyte material is 0.2% to 9.8%, preferably 0.25% to 2.8%. With the mass percentage of the solid electrolyte material being controlled within the foregoing range, it is conducive to controlling the percentages of the cycled products Li₂O, Li_{0.5}TiO₂, Li₃P, and Li₃PO₄ to be within an appropriate range, and the cycled products Li₂O, Li_{0.5}TiO₂, Li₃P, and Li₃PO₄ are fully utilized as electron/ion conductors to reduce the resistance of the negative electrode and improve the lithium precipitation performance while lowering the impedance of the secondary battery, thereby enhancing the rate performance and cycling performance of the secondary battery. In addition, it is conducive to reducing contact between the negative electrode active material and the electrolyte solution, thereby reducing side reactions between the electrolyte solution and the negative electrode active material and improving the lithium precipitation performance of the secondary battery. Therefore, the secondary battery has good rate performance, lithium precipitation performance, and cycling performance.

In an embodiment of this application, based on the mass of negative electrode material layer, a mass percentage A of aluminum is 0.004% to 0.22%, a mass percentage B of titanium is 0.04% to 2.5%, and a mass percentage C of phosphorus is 0.05% to 2.8%. In this application, with the mass percentages of elements Al, Ti, and P being controlled within the foregoing ranges, it is conducive to controlling the percentages of the cycled products Li₂O, Li_{0.5}TiO₂, Li₃P, and Li₃PO₄ to be within an appropriate range, and the cycled products Li₂O, Li_{0.5}TiO₂, Li₃P, and Li₃PO₄ are fully utilized as electron/ion conductors to enhance the ionic conductance of the negative electrode while balancing the electronic conductance of the negative electrode, accelerating the transport of lithium ions in the negative electrode and lowering the resistance of the negative electrode, thereby lowering the impedance of the secondary battery. Therefore, the secondary battery has good rate performance and cycling performance.

In an embodiment of this application, an ionic conductivity of the negative electrode is 1×10⁻⁴ S/cm to 100 S/cm, and a resistance per unit area of the negative electrode is 0.1Ω to 1Ω. With the ionic conductivity of the negative electrode and the resistance per unit area of the negative electrode being controlled within the foregoing ranges, the ionic conductivity of the negative electrode is high, and the resistance of the negative electrode is low. This is conducive to controlling the percentages of the cycled products Li₂O, Li_{0.5}TiO₂, Li₃P, and Li₃PO₄ to be within an appropriate range, and the cycled products Li₂O, Li_{0.5}TiO₂, Li₃P, and Li₃PO₄ are fully utilized as electron/ion conductors to enhance the ionic conductance of the negative electrode while balancing the electronic conductance of the negative electrode, improving the lithium precipitation performance while lowering the impedance of the secondary battery. Therefore, the secondary battery has good rate performance and cycling performance.

In an embodiment of this application, after going N charge-discharge cycles of the secondary battery, the negative electrode material layer is tested using X-ray photoelectron spectroscopy, the negative electrode material layer exhibits characteristic peaks at binding energies from 455 eV to 468 eV, and characteristic peaks corresponding to the peaks of 458±2 eV and 464±2 eV are first characteristic peaks. The first characteristic peaks are attributed to Ti³⁺. The negative electrode material layer having the first characteristic peak indicates that titanium in the solid electrolyte material undergoes reduction reactions during cycling to generate electron/ion conductors, thereby enhancing the ionic conductance of the negative electrode and improving the lithium precipitation performance while lowering the impedance of the secondary battery. Therefore, the secondary battery has good rate performance and cycling performance.

In an embodiment of this application, after going N charge-discharge cycles of the secondary battery, the negative electrode material layer is tested using X-ray photoelectron spectroscopy, the negative electrode material layer exhibits characteristic peaks at binding energies from 455 eV to 468 eV, characteristic peaks corresponding to the peaks of 458±2 eV and 464±2 eV are first characteristic peaks, a characteristic peak corresponding to the peak of 460±2 eV is a second characteristic peak, a peak area of the first characteristic peaks is a, and a peak area of the second characteristic peak is b, wherein 0<a/b≤10¹⁰, and a value of a/b increases with the number of cycles. The first characteristic peaks are attributed to Ti³⁺, and the second characteristic peak is attributed to Ti⁴⁺. With the value of a/b being controlled within the foregoing range, Ti⁴⁺ in the solid electrolyte material is reduced to Ti³⁺ during cycling, and this is conducive to generating electron/ion conductors, thereby enhancing the ionic conductance of the negative electrode and improving the lithium precipitation performance while lowering the impedance of the secondary battery. Therefore, the secondary battery has good rate performance and cycling performance.

In an embodiment of this application, cyclic voltammetry test is performed on a button cell formed by using metallic lithium as the counter electrode and the negative electrode, with a scan rate of 0.1 mV/s and a voltage range from 0 V to 3 V, and the negative electrode exhibits reduction peaks at 0 V to 0.8 V, 1.5 V to 1.8 V, and 2.3 V to 2.5 V. When the negative electrode shows a reduction peak at 0 V to 0.8 V, 1.5 V to 1.8 V, and 2.3 V to 2.5 V, this indicates that the solid electrolyte material of this application undergoes reduction reactions at a low potential and further generates electron/ion conductors, thereby enhancing the ionic conductance of the negative electrode and improving the lithium precipitation performance while lowering the impedance of the secondary battery. In addition, the solid electrolyte material and the generated electron/ion conductors work together to reduce contact between the negative electrode active material and the electrolyte solution, reducing reactions between the electrolyte solution and the negative electrode active material and thereby improving the cycling performance of the secondary battery.

In an embodiment of this application, the solid electrolyte material includes Li₁₊ₓAlₓTi₂₋ₓ(PO₄)₃, where 0<x≤0.5. With the use of the foregoing types of solid electrolyte materials, in the negative electrode material layer, the ionic conductance of the negative electrode can be enhanced while balancing the electronic conductance of the negative electrode, and this is conducive to lowering the impedance of the secondary battery. In addition, the solid electrolyte material added can reduce contact between the negative electrode active material and the electrolyte solution, thereby reducing side reactions between the electrolyte solution and the negative electrode active material and improving the lithium precipitation performance of the secondary battery. Therefore, the secondary battery has good rate performance, lithium precipitation performance, and cycling performance.

In an embodiment of this application, the solid electrolyte material includes Li₁₊ₓAlₓM_{y}Ti_{2-x-y}(PO₄)₃, where 0<x≤0.5,0<y≤0.8, and M includes at least one selected the group consisting of Si, B, Zn, Ge, and Sn. With the use of the foregoing types of solid electrolyte materials, in the negative electrode material layer, the ionic conductance of the negative electrode can be enhanced while balancing the electronic conductance of the negative electrode, and this is conducive to lowering the impedance of the secondary battery. In addition, the solid electrolyte material added can reduce contact between the negative electrode active material and the electrolyte solution, thereby reducing side reactions between the electrolyte solution and the negative electrode active material and improving the lithium precipitation performance of the secondary battery. Therefore, the secondary battery has good rate performance, lithium precipitation performance, and cycling performance.

In an embodiment of this application, particles of the solid electrolyte material have a carbon material on a surface thereof, carbon material includes at least one selected from the group consisting of carbon nanotubes, graphene, and porous carbon, and a thickness of the carbon material is 1 nm to 50 nm. With the thickness of the carbon material being controlled within the foregoing range, it is conducive to enhancing the ion conduction between interfaces of the negative electrode active material, thereby enhancing the kinetic performance of the negative electrode active material in the secondary batteries. This is conducive to controlling the percentages of the cycled products Li₂O, Li_{0.5}TiO₂, Li₃P, and Li₃PO₄ to be within an appropriate range, and the cycled products Li₂O, Li_{0.5}TiO₂, Li₃P, and Li₃PO₄ are fully utilized as electron/ion conductors to improve the lithium precipitation performance while lowering the impedance of the secondary battery. In addition, this is conducive to alleviating the volume swelling of the negative electrode active material during cycling and reducing side reactions between the electrolyte solution and the negative electrode active material. Therefore, the secondary battery has good rate performance, lithium precipitation performance, and cycling performance.

In an embodiment of this application, the negative electrode active material includes at least one selected from the group consisting of graphite, hard carbon, silicon, a silicon-carbon material, and a silicon-oxide material. The use of the foregoing type of negative electrode active material is conducive to obtaining a secondary battery with good cycling performance.

In an embodiment of this application, an average particle size of the negative electrode active material is 5 μm to 25 μm. With the average particle size of the negative electrode active material being controlled within the foregoing range, the solid electrolyte material can be evenly dispersed in the negative electrode material layer. This is conducive to controlling the percentages of the cycled products Li₂O, Li_{0.5}TiO₂, Li₃P, and Li₃PO₄ to be within an appropriate range, and the cycled products Li₂O, Li_{0.5}TiO₂, Li₃P, and Li₃PO₄ are fully utilized as electron/ion conductors to enhance the ionic conductance of the negative electrode while balancing the electronic conductance of the negative electrode, improving the lithium precipitation performance while lowering the impedance of the secondary battery. Therefore, the secondary battery has good rate performance and cycling performance.

In an embodiment of this application, a porosity of the negative electrode material layer is 18% to 35%. With the porosity of the negative electrode material layer being controlled within the foregoing range, it is conducive to the distribution of the solid electrolyte material in the negative electrode material layer to accelerate the transport of lithium ions in the negative electrode. This is conducive to controlling the percentages of the cycled products Li₂O, Li_{0.5}TiO₂, Li₃P, and Li₃PO₄ to be within an appropriate range, and the cycled products Li₂O, Li_{0.5}TiO₂, Li₃P, and Li₃PO₄ are fully utilized as electron/ion conductors to improve the lithium precipitation performance while lowering the impedance of the secondary battery. The volume swelling of the negative electrode active material during cycling is also alleviated. Therefore, the secondary battery has good rate performance and cycling performance.

In an embodiment of this application, a coating weight of the negative electrode material layer is 5 mg/cm² to 50 mg/cm². With the coating weight of the negative electrode material layer being controlled within the foregoing range, it is conducive to forming suitable stacking morphology inside the negative electrode material layer to improve the infiltration pathway of the electrolyte solution. This is conducive to controlling the percentages of the cycled products Li₂O, Li_{0.5}TiO₂, Li₃P, and Li₃PO₄ to be within an appropriate range, and the cycled products are fully utilized as electron/ion conductors to improve the lithium precipitation performance while lowering the impedance of the secondary battery, thereby enhancing the rate performance and cycling performance of the secondary battery. In addition, this is conducive to obtaining a secondary battery with high energy density.

In an embodiment of this application, the electrolyte solution includes a double bond compound. The double bond compound includes a compound A. The compound A includes at least one selected from the group consisting of ethylene carbonate and propylene carbonate, and based on a mass of the electrolyte solution, a mass percentage of the compound A is 15% to 80%. With the use of foregoing type of compound A and its mass percentage being controlled within the foregoing range, it is conducive to catalyzing the solid electrolyte material for in-situ reactions, thereby controlling the percentages of the cycled products Li₂O, Li_{0.5}TiO₂, Li₃P, and Li₃PO₄ to be within an appropriate range, and the cycled products are fully utilized as electron/ion conductors to enhance the ionic conductance of the negative electrode and improve the lithium precipitation performance while lowering the impedance of the secondary battery. Therefore, the secondary battery has good rate performance and cycling performance.

In an embodiment of this application, the electrolyte solution includes a double bond compound. The double bond compound includes a compound B. The compound B includes at least one selected from the group consisting of vinylene carbonate and fluoroethylene carbonate, and based on the mass of the electrolyte solution, a mass percentage of the compound B is 1.5% to 12.5%. With the use of foregoing type of compound B and its mass percentage being controlled within the foregoing range, it is conducive to catalyzing the solid electrolyte material for in-situ reactions, thereby controlling the percentages of the cycled products Li₂O, Li_{0.5}TiO₂, Li₃P, and Li₃PO₄ to be within an appropriate range, and the cycled products are fully utilized as electron/ion conductors to enhance the ionic conductance of the negative electrode, thereby lowering the impedance of the secondary battery. Therefore, the secondary battery has good rate performance and cycling performance.

A second aspect of this application provides an electronic apparatus including the secondary battery according to any one of the foregoing embodiments. The secondary battery provided in this application has good rate performance, lithium precipitation performance, and cycling performance, so the electronic apparatus of this application has a longer service life.

This application has the following beneficial effects:

This application provides a secondary battery and an electronic apparatus.

The secondary battery includes a positive electrode, a negative electrode, and an electrolyte solution. The negative electrode includes a negative electrode material layer. The negative electrode material layer includes a negative electrode active material and a solid electrolyte material. The solid electrolyte material contains aluminum, titanium, phosphorus. The secondary battery is cycled at an ambient temperature of 25° C., and after going N charge-discharge cycles, the negative electrode material layer comprises Li₂O, Li_{0.5}TiO₂, Li₃P, and Li₃PO₄, wherein 10≤N≤2000, and each of N charge-discharge cycles consisting of charging to 4.45 V at a constant current of 0.02 C, then charging to 0.025 C at a constant voltage of 4.45 V, then leaving standing for 5 minutes, and then discharging to 3.0 V at 0.5 C; and based on a mass of the negative electrode material layer, a mass percentage of Li₂O is 0.006% to 1.25%, a mass percentage of Li_{0.5} TiO₂ is 0.005% to 2%, a mass percentage of Li₃P is 0.003% to 0.8%, and a mass percentage of Li₃PO₄ is 0.006% to 1.6%. With the foregoing settings, Li₂O, Li_{0.5}TiO₂, Li₃P, and Li₃PO₄ in appropriate percentages are used as electron/ion conductors, enhancing the ionic conductance of the negative electrode while balancing the electronic conductance of the negative electrode, and improving the lithium precipitation performance while lowering the impedance of the secondary battery, thereby enhancing the rate performance and cycling performance of the secondary battery. In addition, the solid electrolyte material added can reduce contact between the negative electrode active material and the electrolyte solution, thereby reducing side reactions between the electrolyte solution and the negative electrode active material, and work synergistically with the cycled products Li₂O, Li_{0.5}TiO₂, Li₃P, and Li₃PO₄ to further improve the lithium precipitation performance of the secondary battery. Therefore, the secondary battery of this application has good rate performance, lithium precipitation performance, and cycling performance.

Certainly, when any product or method of this application is implemented, all advantages described above are not necessarily demonstrated simultaneously.

### BRIEF DESCRIPTION OF DRAWINGS

To describe the technical solutions in some embodiments of this application or in the prior art more clearly, the following briefly describes the accompanying drawings required for describing these embodiments or the prior art. Apparently, the accompanying drawings in the following descriptions show merely some embodiments of this application, and persons of ordinary skill in the art may still derive other embodiments from these accompanying drawings.

FIG. 1 is a partial schematic structural diagram of a negative electrode plate according to an embodiment of this application;

FIG. 2 is a scanning electron microscope image of Comparative example 1 of this application at a magnification of 10000;

FIG. 3 is a scanning electron microscope image of Comparative example 1 of this application at a magnification of 1000;

FIG. 4 is a scanning electron microscope image of Example 1-1 of this application at a magnification of 10000;

FIG. 5 is a scanning electron microscope image of Example 1-1 of this application at a magnification of 1000;

FIG. 6 is a surface mapping image of element Si in a cross-section of a negative electrode of Example 1-1 of this application;

FIG. 7 is a surface mapping image of element C in a cross-section of a negative electrode of Example 1-1 of this application;

FIG. 8 is a surface mapping image of titanium in a cross-section of a negative electrode of Example 1-1 of this application;

FIG. 9 is a surface mapping image of aluminum in a cross-section of a negative electrode of Example 1-1 of this application;

FIG. 10 is a line mapping image of energy spectrum analysis of Example 1-1 of this application;

FIG. 11 is a current-voltage curve of Example 1-1 of this application;

FIG. 12 is a current-voltage curve according to an embodiment of this application; and

FIG. 13 is a comparison diagram of cycling performance between Example 1-1 and Comparative example 1 of this application.

Reference signs: negative electrode 100; negative electrode material layer 10; negative electrode active material 11; solid electrolyte material 12; and negative electrode current collector 20.

### DETAILED DESCRIPTION

The following clearly and completely describes the technical solutions in some embodiments of this application with reference to the accompanying drawings in some embodiments of this application. Apparently, the described embodiments are only some rather than all of these embodiments of this application. All other embodiments obtained by persons skilled in the art based on this application shall fall within the protection scope of this application.

It should be noted that in the invention of this application, the lithium-ion battery is used as an example of the secondary battery to illustrate this application. However, the secondary battery of this application is not limited to the lithium-ion battery.

Currently, in the prior art, the kinetic performance of the lithium-ion battery is generally improved by optimization of electrolyte solution, surface treatment of active material, or porous treatment of electrode plate, but the operation process is complicated and costly, and in addition, porous treatment of electrode plate also causes a loss of energy density of the lithium-ion battery. In addition, in the process of continuous lithium deintercalation and intercalation, the negative electrode active material is prone to breakage, and side reactions with the electrolyte solution continue, leading to the occurrence of lithium precipitation. In view of this, this application provides a secondary battery and an electronic apparatus, to lower the impedance of the secondary battery and improve the rate performance, lithium precipitation performance and cycling performance of the secondary battery.

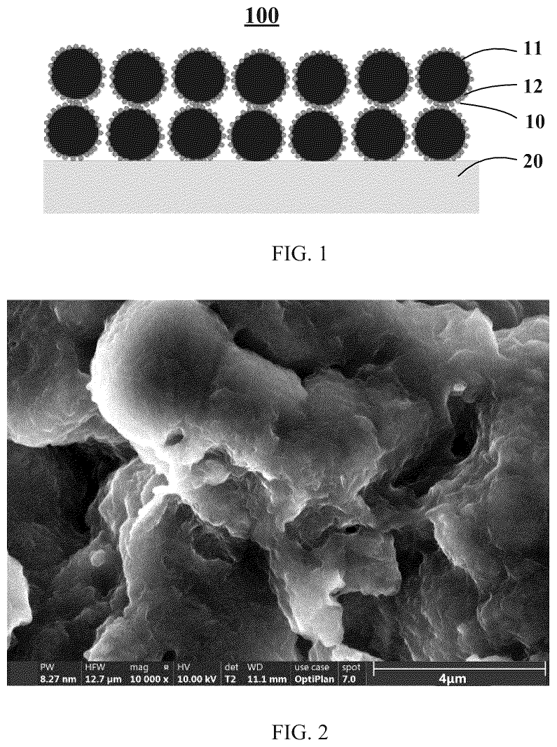

A first aspect of this application provides a secondary battery and an electronic apparatus. The secondary battery includes a positive electrode, a negative electrode, and an electrolyte solution. As shown in FIG. 1, the negative electrode 100 includes a negative electrode material layer 10 and a negative electrode current collector 20. The negative electrode material layer 10 includes a negative electrode active material 11 and a solid electrolyte material 12. At least a portion of the solid electrolyte material 12 is present on the surface of the negative electrode active material 11, and a portion of the solid electrolyte material is present between particle pores of the negative electrode active material. The solid electrolyte material contains aluminum, titanium, phosphorus. The secondary battery is cycled at an ambient temperature of 25° C., and after going N charge-discharge cycles, the negative electrode material layer comprises Li₂O, Li_{0.5}TiO₂, Li₃P, and Li₃PO₄, wherein 10≤N≤2000, and each of N charge-discharge cycles consisting of charging to 4.45 V at a constant current of 0.02 C, then charging to 0.025 C at a constant voltage of 4.45 V, then leaving standing for 5 minutes, and then discharging to 3.0 V at 0.5 C; and based on a mass of the negative electrode material layer, a mass percentage D of Li₂O is 0.006% to 1.25%, a mass percentage E of Li_{0.5}TiO₂ is 0.005% to 2%, a mass percentage F of Li₃P is 0.003% to 0.8%, and a mass percentage G of Li₃PO₄ is 0.006% to 1.6%. For example, the mass percentage D of Li₂O is 0.006%, 0.008%, 0.010%, 0.011%, 0.013%, 0.015%, 0.017%, 0.02%, 0.03%, 0.05%, 0.07%, 0.1%, 0.3%, 0.5%, 0.7%, 1.0%, 1.2%, or 1.25%, or a range defined by any two of foregoing values, the mass percentage E of Li_{0.5}TiO₂ is 0.005%, 0.006%, 0.007%, 0.008%, 0.009%, 0.01%, 0.013%, 0.015%, 0.017%, 0.02%, 0.03%, 0.05%, 0.07%, 0.1%, 0.3%, 0.5%, 0.7%, 1%, 1.3%, 1.5%, 1.7%, 1.9%, or 2%, or a range defined by any two of foregoing values, the mass percentage F of Li₃P is 0.003%, 0.004%, 0.005%, 0.007%, 0.01%, 0.03%, 0.04%, 0.05%, 0.06%, 0.07%, 0.08%, 0.09%, 0.1%, 0.2%, 0.3%, 0.4%, 0.5%, 0.6%, 0.7%, or 0.8%, or a range defined by any two of foregoing values, the mass percentage G of Li₃PO₄ is 0.006%, 0.008%, 0.01%, 0.013%, 0.015%, 0.017%, 0.02%, 0.05%, 0.07%, 0.1%, 0.2%, 0.3%, 0.4%, 0.5%, 0.6%, 0.7%, 0.8%, 0.9%, 1%, 1.1%, 1.2%, 1.23%, 1.25%, 1.27%, 1.3%, 1.33%, 1.35%, 1.37%, 1.4%, 1.43%, 1.45%, 1.47%, 1.5%, 1.53%, 1.55%, 1.57%, or 1.6%, or a range defined by any two of foregoing values. The negative electrode material layer is added with the solid electrolyte material of this application. The solid electrolyte material of this application itself has high ionic conductance and can enhance the ion conduction within the negative electrode material layer when added to the interior of the negative electrode material layer. In addition, the solid electrolyte material of this application undergoes reduction reactions at voltages below 2.5 V to generate electron/ion conductors. The in-situ reactions occur on the surface of the negative electrode active material, reducing contact between the negative electrode active material and the electrolyte solution and reducing reactions between the electrolyte solution and the negative electrode active material, thereby improving the cycling performance of the secondary battery. Furthermore, due to its catalytic activity, titanium in the solid electrolyte material can catalyze and polymerize double bond compounds in the electrolyte solution, and this is conducive to forming a polymer protective layer on the surface of the negative electrode active material, further improving the cycling performance of the secondary battery. Moreover, the solid electrolyte material of this application has a high dielectric constant and therefore can affect the solvation structure of lithium ions, thereby reducing the desolvation energy and improving the transport kinetic performance of lithium ions. Therefore, the cycling performance, rate performance, and safety performance of the secondary battery are improved. When the percentages of products of the in-situ reactions are within the ranges in this application, the effects can be made more significant. Too-small amounts of products Li₂O, Li_{0.5}TiO₂, Li₃P, and Li₃PO₄ generated after cycling have insignificant improvement in the ionic conductance of the negative electrode, and the impedance of the secondary battery is difficult to lower; and excessive amounts of products Li₂O, Li_{0.5}TiO₂, Li₃P, and Li₃PO₄ generated after cycling affect the energy density of the secondary battery. With the addition of a solid electrolyte material to the negative electrode material layer, the solid electrolyte material is capable of reacting in situ to generate products Li₂O, Li_{0.5}TiO₂, Li₃P, and Li₃PO₄. When the cycled products Li₂O, Li_{0.5}TiO₂, Li₃P, and Li₃PO₄ are controlled within the ranges in this application, as electron/ion conductors, Li₂O, Li_{0.5}TiO₂, Li₃P, and Li₃PO₄ in the negative electrode material layer can enhance the ionic conductance of the negative electrode while balancing the electronic conductance of the negative electrode. The solid electrolyte material itself has high ionic conductivity and electronic conductivity. Dispersing the solid electrolyte material on the surface of the negative electrode active material and in the particle pores of the negative electrode active material can alleviate the problem of large interface impedance and internal impedance due to the poor ion transport properties of the negative electrode active material itself, lowering the resistance of the negative electrode and thereby lowering the impedance of the secondary battery and enhancing the rate performance of the secondary battery. In addition, the solid electrolyte material added can reduce contact between the negative electrode active material and the electrolyte solution, thereby reducing side reactions between the electrolyte solution and the negative electrode active material, improving the lithium precipitation performance of the secondary battery and thereby enhancing the cycling performance of the secondary battery. Therefore, the secondary battery has good rate performance, lithium precipitation performance, and cycling performance. In this application, the percentages of cycled products Li₂O, Li_{0.5}TiO₂, Li₃P, and Li₃PO₄ can be controlled by adjusting the type of the solid electrolyte material and the amount of the solid electrolyte material added to the negative electrode material layer.

In an embodiment of this application, based on the mass of negative electrode material layer, a mass percentage A of aluminum is 0.004% to 0.22%, a mass percentage B of titanium is 0.04% to 2.5%, and a mass percentage C of phosphorus is 0.05% to 2.8%. For example, the mass percentage A of aluminum is 0.004%, 0.01%, 0.02%, 0.04%, 0.06%, 0.08%, 0.1%, 0.12%, 0.14%, 0.16%, 0.18%, 0.2%, 0.21%, 0.22% or a range composed of any two of these values; the mass percentage B of titanium is 0.04%, 0.06%, 0.1%, 0.2%, 0.4%, 0.6%, 0.8%, 1%, 1.2%, 1.4%, 1.6%, 1.8%, 2%, 2.2%, 2.5% or a range composed of any two of these values; and the mass percentage C of phosphorus is 0.05%, 0.08%, 0.1%, 0.2%, 0.4%, 0.6%, 0.8%, 1%, 1.2%, 1.4%, 1.6%, 1.8%, 2%, 2.2%, 2.5%, 2.8% or a range composed of any two of these values. In this application, with the mass percentages of elements Al, Ti, and P being controlled within the foregoing ranges, it is conducive to controlling the percentages of the cycled products Li₂O, Li_{0.5}TiO₂, Li₃P, and Li₃PO₄ to be within an appropriate range, and the cycled products Li₂O, Li_{0.5}TiO₂, Li₃P, and Li₃PO₄ are fully utilized as electron/ion conductors to enhance the ionic conductance of the negative electrode while balancing the electronic conductance of the negative electrode, accelerating the transport of lithium ions in the negative electrode and lowering the resistance of the negative electrode, thereby lowering the impedance of the secondary battery and enhancing the rate performance and cycling performance of the secondary battery. In this application, the percentages of elements Al, Ti, and P in the negative electrode material layer can be controlled by adjusting the type of the solid electrolyte material and the amount of the solid electrolyte material added to the negative electrode material layer.

In an embodiment of this application, based on the mass of the negative electrode material layer, the mass percentage Y of the solid electrolyte material is 0.2% to 9.8%, preferably 0.25% to 2.8%. For example, the mass percentage Y of the solid electrolyte material is 0.2%, 0.25%, 1%, 2%, 2.8%, 3%, 4%, 5%, 6%, 7%, 8%, or 9.8%, or a range defined by any two of foregoing values. With the mass percentage of the solid electrolyte material being controlled within the foregoing range, it is conducive to controlling the percentages of the cycled products Li₂O, Li_{0.5}TiO₂, Li₃P, and Li₃PO₄ to be within an appropriate range, and the cycled products Li₂O, Li_{0.5}TiO₂, Li₃P, and Li₃PO₄ are fully utilized as electron/ion conductors to alleviate the problem of large interface impedance and internal impedance due to the poor ion transport properties of the negative electrode active material itself, lowering the resistance of the negative electrode and thereby lowering the impedance of the secondary battery and enhancing the rate performance of the secondary battery. In addition, it is conducive to reducing contact between the negative electrode active material and the electrolyte solution, thereby reducing side reactions between the electrolyte solution and the negative electrode active material and improving the lithium precipitation performance of the secondary battery. Therefore, the secondary battery has good rate performance, lithium precipitation performance, and cycling performance.

In an embodiment of this application, the ionic conductivity of the solid electrolyte material is 1×10⁻⁶ S/cm to 1×10⁻⁴ S/cm, and the electronic conductivity of the solid electrolyte material is 1×10⁻¹² S/cm to 1×10⁻⁸ S/cm. For example, the ionic conductivity of the solid electrolyte material is 1×10⁻⁶ S/cm, 5×10⁻⁶ S/cm, 1×10⁻⁵ S/cm, 5×10⁻⁵ S/cm, or 1×10⁻⁴ S/cm, or a range defined by any two of foregoing values; and the electronic conductivity of the solid electrolyte material is 1×10⁻¹² S/cm, 1×10⁻¹¹ S/cm, 1×10⁻¹⁰ S/cm, 1×10⁻⁹ S/cm, or 1×10⁻⁸ S/cm, or a range defined by any two of foregoing values. When the ionic conductivity and electronic conductivity of the solid electrolyte material are with the foregoing ranges, the solid electrolyte material added to the negative electrode material layer is conducive to controlling the percentages of the cycled products Li₂O, Li_{0.5}TiO₂, Li₃P, and Li₃PO₄ to be within an appropriate range, and the cycled products Li₂O, Li_{0.5}TiO₂, Li₃P, and Li₃PO₄ are fully utilized as electron/ion conductors to enhance the ionic conductance of the negative electrode while balancing the electronic conductance of the negative electrode, accelerating the transport of lithium ions in the negative electrode and lowering the resistance of the negative electrode, thereby lowering the impedance of the secondary battery and enhancing the rate performance and cycling performance of the secondary battery.

In an embodiment of this application, an ionic conductivity k of the negative electrode is 1×10⁻⁴ S/cm to 100 S/cm, and a resistance R per unit area of the negative electrode is 0.1Ω to 1Ω. For example, the ionic conductivity K of the negative electrode is 1×10⁻⁴ S/cm, 1×10⁻³ S/cm, 1×10⁻² S/cm, 0.1 S/cm, 1 S/cm, 10 S/cm, 50 S/cm, or 100 S/cm, or a range defined by any two of foregoing values; and the resistance R per unit area of the negative electrode is 0.1Ω, 0.2Ω, 0.4Ω, 0.6Ω, 0.8Ω, or 1Ω, or a range defined by any two of foregoing values. When the ionic conductivity and the resistance per unit area of the negative electrode are with the foregoing ranges, the ionic conductivity of the negative electrode is high, and the resistance per unit area of the negative electrode is low. This is conducive to controlling the percentages of the cycled products Li₂O, Li_{0.5}TiO₂, Li₃P, and Li₃PO₄ to be within an appropriate range, and the cycled products Li₂O, Li_{0.5} TiO₂, Li₃P, and Li₃PO₄ are fully utilized as electron/ion conductors to enhance the ionic conductance of the negative electrode while balancing the electronic conductance of the negative electrode, improving the lithium precipitation performance while lowering the impedance of the secondary battery. Therefore, the secondary battery has good rate performance and cycling performance. In this application, the unit area refers to 1 cm².

In an embodiment of this application, the negative electrode material layer in the secondary battery before cycling is tested using X-ray photoelectron spectroscopy, and the negative electrode material layer exhibits characteristic peaks at the peaks of binding energies of 460±2 eV and 466±2 eV. The characteristic peaks corresponding to the peak of 460±2 eV and 466±2 eV are attributed to Ti⁴⁺.

In an embodiment of this application, after going N charge-discharge cycles of the secondary battery, the negative electrode material layer is tested using X-ray photoelectron spectroscopy, the negative electrode material layer exhibits characteristic peaks at binding energies from 455 eV to 468 eV, and characteristic peaks corresponding to the peaks of 458±2 eV and 464±2 eV are first characteristic peaks. The first characteristic peaks are attributed to Ti³⁺. The negative electrode material layer having the first characteristic peaks indicates that titanium in the solid electrolyte material undergoes reduction reactions during cycling, and this is conducive to generating electron/ion conductors. In addition, Ti³⁺ can further catalyze the polymerization of double bond compounds in the electrolyte solution, and this is conducive to forming a polymer protective layer on the surface of the negative electrode active material, further reducing contact between the negative electrode active material and the electrolyte solution, reducing side reactions on the surface of the negative electrode active material, and thereby enhancing the ionic conductance of the negative electrode and improving the lithium precipitation performance while lowering the impedance of the secondary battery. Therefore, the secondary battery has good rate performance and cycling performance.

In an embodiment of this application, after going N charge-discharge cycles of the secondary battery, the negative electrode material layer is tested using X-ray photoelectron spectroscopy, the negative electrode material layer exhibits characteristic peaks at binding energies from 455 eV to 468 eV, characteristic peaks corresponding to the peaks of 458±2 eV and 464±2 eV are first characteristic peaks, a characteristic peak corresponding to the peak of 460±2 eV is a second characteristic peak, a peak area of the first characteristic peaks is a, and a peak area of the second characteristic peak is b, wherein 0<a/b≤10¹⁰, and a value of a/b increases with the number of cycles. For example, the value of a/b is 1, 10, 100, 10⁴, 10⁶, 10⁸, or 10¹⁰, or a range composed of any two of these values. The first characteristic peaks are attributed to Ti³⁺, and the second characteristic peak is attributed to Ti⁴⁺. With the value of a/b being controlled within the foregoing range, Ti⁴⁺ in the solid electrolyte material is reduced to Ti³⁺ during cycling, and this is conducive to generating electron/ion conductors, thereby enhancing the ionic conductance of the negative electrode and improving the lithium precipitation performance while lowering the impedance of the secondary battery. Therefore, the secondary battery has good rate performance and cycling performance.

In an embodiment of this application, cyclic voltammetry test is performed on a button cell formed by using metallic lithium as the counter electrode and the negative electrode, with a scan rate of 0.1 mV/s and a voltage range from 0 V to 3 V, and the negative electrode exhibits reduction peaks at 0 V to 0.8 V, 1.5 V to 1.8 V, and 2.3 V to 2.5 V. When the negative electrode shows a reduction peak at 0 V to 0.8 V, 1.5 V to 1.8 V, and 2.3 V to 2.5 V, this indicates that the solid electrolyte material of this application undergoes reduction reactions at a low potential, thereby enhancing the ionic conductance of the negative electrode and improving the lithium precipitation performance while lowering the impedance of the secondary battery. In addition, the solid electrolyte material and the generated electron/ion conductors work together to reduce contact between the negative electrode active material and the electrolyte solution, reducing reactions between the electrolyte solution and the negative electrode active material and thereby improving the cycling performance of the secondary battery.

In an embodiment of this application, the solid electrolyte material includes Li₁₊ₓAlₓTi₂₋ₓ(PO₄)₃, where 0<x≤0.5. For example, x may be 0.1, 0.2, 0.3, 0.4, or 0.5, or a range defined by any two of the foregoing values, and the solid electrolyte material may be Li_{1.1}Al_{0.1}Ti_{1.9} (PO₄)₃, Li_{1.2}Al_{0.2} Ti_{1.8} (PO₄)₃, Li_{1.3}Al_{0.3} Ti_{1.7} (PO₄)₃, Li_{1.4}Al_{0.4}Ti_{1.6} (PO₄)₃, or Li_{1.5}Al_{0.5}Ti_{1.5} (PO₄)₃. With the use of the foregoing types of solid electrolyte materials, in the negative electrode material layer, the ionic conductance of the negative electrode can be enhanced while balancing the electronic conductance of the negative electrode, and this is conducive to accelerating the conduction of lithium ions within the negative electrode and lowering the resistance of the negative electrode, thereby lowering the impedance of the secondary battery and improving the rate performance of the secondary battery. In addition, the solid electrolyte material added can reduce contact between the negative electrode active material and the electrolyte solution, thereby reducing side reactions between the electrolyte solution and the negative electrode active material and improving the lithium precipitation performance of the secondary battery. Therefore, the secondary battery has good rate performance, lithium precipitation performance, and cycling performance.

In an embodiment of this application, the solid electrolyte material includes Li₁₊ₓAlₓM_{y}Ti_{2-x-y}(PO₄)₃, where 0<x≤0.5, 0<y≤0.8, and M includes at least one selected the group consisting of Si, B, Zn, Ge, and Sn. For example, x can be 0.1, 0.2, 0.3, 0.4, 0.5 or a range composed of any two of these values; and y can be 0.1, 0.2, 0.3, 0.4, 0.5, 0.6, 0.7, 0.8 or a range defined by any two of foregoing values. The solid electrolyte material may be Li_{1.3}Al_{0.3}Sn_{0.1}Ti_{1.6} (PO₄)₃, Li_{1.3}Al_{0.3}Ge_{0.1} Ti_{1.6} (PO₄)₃, Li_{1.3}Al_{0.3}Si_{0.1} Ti_{1.6} (PO₄)₃, or the like. With the use of the foregoing types of solid electrolyte materials, in the negative electrode material layer, the ionic conductance of the negative electrode can be enhanced while balancing the electronic conductance of the negative electrode, and this is conducive to accelerating the conduction of lithium ions within the negative electrode and lowering the resistance of the negative electrode, thereby lowering the impedance of the secondary battery and improving the rate performance of the secondary battery. In addition, the solid electrolyte material added can reduce contact between the negative electrode active material and the electrolyte solution, thereby reducing side reactions between the electrolyte solution and the negative electrode active material and improving the lithium precipitation performance of the secondary battery. Therefore, the secondary battery has good rate performance, lithium precipitation performance, and cycling performance.

In an embodiment of this application, particles of the solid electrolyte material have a carbon material on a surface thereof, carbon material includes at least one selected from the group consisting of carbon nanotubes, graphene, and porous carbon, and a thickness of the carbon material is 1 nm to 50 nm. For example, the thickness of the carbon material is 1 nm, 3 nm, 7 nm, 10 nm, 14 nm, 18 nm, 20 nm, 23 nm, 27 nm, 30 nm, 33 nm, 37 nm, 40 nm, 43 nm, 47 nm, or 50 nm, or a range defined by any two of foregoing values. With the thickness of the carbon material being controlled within the foregoing range, the solid electrolyte material is dispersed on the surface of the negative electrode active material and in the particle pores of the negative electrode active material, and it is conducive to enhancing the ion conduction between interfaces of the negative electrode active material and thus enhancing the kinetic performance of the negative electrode active material in the secondary batteries and lowering the resistance of the negative electrode plate. This is conducive to controlling the percentages of the cycled products Li₂O, Li_{0.5}TiO₂, Li₃P, and Li₃PO₄ to be within an appropriate range, and the cycled products Li₂O, Li_{0.5}TiO₂, Li₃P, and Li₃PO₄ are fully utilized as electron/ion conductors to improve the lithium precipitation performance while lowering the impedance of the secondary battery. In addition, this is conducive to alleviating the volume swelling of the negative electrode active material during cycling, reducing side reactions between the electrolyte solution and the negative electrode active material, and improving the lithium precipitation performance of the secondary battery. Therefore, the secondary battery has good rate performance, lithium precipitation performance, and cycling performance. Dv50 of the solid electrolyte material is not particularly limited in this application, provided that the objective of this application can be achieved. For example, Dv50 of the solid electrolyte material is 0.1 μm to 2 μm, preferably 0.1 μm to 1 μm.

The preparation method of solid electrolyte material with carbon material on the particle surface is not particularly limited in this application, provided that the objective of this application can be achieved. For example, the preparation method of solid electrolyte material with carbon material on the particle surface includes but is not limited to the following steps: using chemical vapor deposition (CVD) for preparation, placing a solid electrolyte material in a tube furnace, and introducing combustible gas for calcination, with a calcination temperature of 600° C. to 1200° C. and a calcination time of 1 hour to 6 hours, to obtain a solid electrolyte material with carbon material on the particle surface. In this application, solid electrolyte materials with carbon material of different thicknesses on the surface can be obtained by controlling the calcination temperature and calcination time. The thickness of the carbon material on the surface of a solid electrolyte material obtained with a higher calcination temperature and a longer calcination time is larger. The thickness of the carbon material on the surface of a solid electrolyte material obtained with a lower calcination temperature and a shorter calcination time is smaller.

In an embodiment of this application, the negative electrode active material includes at least one selected from the group consisting of graphite, hard carbon, silicon, a silicon-carbon material, and a silicon-oxide material. The use of the foregoing type of negative electrode active material is conducive to obtaining a secondary battery with good cycling performance.

In an embodiment of this application, an average particle size of the negative electrode active material is 5 μm to 25 μm. For example, the average particle size of the negative electrode active material is 5 μm, 10 μm, 15 μm, 20 μm, or 25 μm, or a range defined by any two of the foregoing values. With the average particle size of the negative electrode active material being controlled within the foregoing range, it is conducive to dispersing the solid electrolyte material in the particle pores of the negative electrode active material and the negative electrode active material, and the solid electrolyte material can be evenly dispersed in the negative electrode material layer. This is conducive to controlling the percentages of the cycled products Li₂O, Li_{0.5} TiO₂, Li₃P, and Li₃PO₄ to be within an appropriate range, and the cycled products Li₂O, Li_{0.5}TiO₂, Li₃P, and Li₃PO₄ are fully utilized as electron/ion conductors to improve the lithium precipitation performance while lowering the impedance of the secondary battery and enhance the ionic conductance of the negative electrode plate while balancing the electronic conductance of the negative electrode plate, lowering the resistance of the negative electrode plate and thereby lowering the impedance of the secondary battery. Therefore, the secondary battery has good rate performance and cycling performance. In this application, the average particle size can be understood as an equivalent diameter. The equivalent diameter generally refers to a diameter of a sphere with the same volume as an irregularly shaped object. In this application, a negative electrode plate is obtained, an area of negative electrode active material particles under test on the surface of the negative electrode plate is measured, and then a diameter of a circle with the same area is used as the equivalent diameter of the negative electrode active material particles under test. The manner of controlling the average particle size of the negative electrode active material is not particularly limited in this application, provided that the objectives of this application can be achieved. For example, the controlling can be achieved by crushing, grinding, or ball milling the negative electrode active materials.

In an embodiment of this application, the porosity φ of the negative electrode material layer is 18% to 35%. For example, the porosity φ of the negative electrode material layer is 18%, 20%, 25%, 30%, or 35%, or a range defined by any two of foregoing values. With the porosity of the negative electrode material layer being controlled within the foregoing range, it is conducive to the distribution of the solid electrolyte material in the negative electrode material layer to accelerate the transport of lithium ions in the negative electrode. This is conducive to controlling the percentages of the cycled products Li₂O, Li_{0.5}TiO₂, Li₃P, and Li₃PO₄ to be within an appropriate range, and the cycled products Li₂O, Li_{0.5}TiO₂, Li₃P, and Li₃PO₄ are fully utilized as electron/ion conductors to improve the lithium precipitation performance while lowering the impedance of the secondary battery, thereby lowering the impedance of the secondary battery and alleviating the volume swelling of the negative electrode active material during cycling. Therefore, the secondary battery has good rate performance and cycling performance. In this application, the porosity of the negative electrode material layer can be controlled by any means known to those skilled in the art. The means is not particularly limited in this application, provided that the objectives of this application can be achieved. For example, the porosity of the negative electrode material layer can be adjusted by adjusting the cold pressing pressure. A greater cold pressing pressure makes the porosity of the negative electrode material layer smaller.

In an embodiment of this application, the coating weight CW of the negative electrode material layer is 5 mg/cm² to 50 mg/cm². For example, the coating weight CW of the negative electrode material layer is 5 mg/cm², 10 mg/cm², 20 mg/cm², 30 mg/cm², 40 mg/cm², or 50 mg/cm², or a range defined by any two of the foregoing values. With the coating weight of the negative electrode material layer being controlled within the foregoing range, it is conducive to forming suitable stacking morphology inside the negative electrode material layer to improve the infiltration pathway of the electrolyte solution. This is conducive to controlling the percentages of the cycled products Li₂O, Li_{0.5}TiO₂, Li₃P, and Li₃PO₄ to be within an appropriate range, and the cycled products are fully utilized as electron/ion conductors to improve the lithium precipitation performance while lowering the impedance of the secondary battery, thereby enhancing the rate performance and cycling performance of the secondary battery. In addition, this is conducive to obtaining a secondary battery with high energy density. In this application, the coating weight of the negative electrode material layer can be controlled by any means known to those skilled in the art. For example, when a negative electrode slurry is applied to the surface of a negative electrode current collector, the coating amount of the negative electrode slurry can be increased based on a specific solid content of the negative electrode slurry to increase the coating weight of the negative electrode material layer. The means is not particularly limited in this application, provided that the objectives of this application can be achieved.

In this application, the negative electrode includes a negative electrode current collector, and a negative electrode material layer is disposed on at least one surface of the negative electrode current collector. It can be understood that the negative electrode material layer can be disposed on one surface of the negative electrode current collector in its thickness direction, or may be disposed on two surfaces of the negative electrode current collector in its thickness direction. It should be noted that the “surface” herein may be an entire region of the surface of the negative electrode current collector, or may be a partial region of the surface of the negative electrode current collector. This is not particularly limited in this application, provided that the objectives of this application can be achieved. The negative electrode current collector is not particularly limited in this application, provided that the objectives of this application can be achieved. For example, the negative electrode current collector may include copper foil, copper alloy foil, nickel foil, stainless steel foil, titanium foil, foam nickel, foam copper, or a composite current collector (such as a lithium-copper composite current collector, a carbon-copper composite current collector, a nickel-copper composite current collector, or a titanium-copper composite current collector). The thickness of the negative electrode current collector is not particularly limited in this application, provided that the objectives of this application can be achieved. For example, a thickness of the negative electrode current collector is 4 μm to 20 μm. The negative electrode material layer may further include a negative electrode binder, a conductive agent, and a dispersant. The type of the negative electrode binder in the negative electrode material layer is not particularly limited in this application, provided that the objectives of this application can be achieved. For example, the negative electrode binder may include but is not limited to at least one of polyvinylidene fluoride, polyvinylidene fluoride-hexafluoropropylene copolymers, polyamide, polyacrylonitrile, polyacrylate ester, polyacrylic acid, polyacrylate, polyvinylpyrrolidone, polyvinyl ether, polymethyl methacrylate, polytetrafluoroethylene, or polyhexafluoropropylene. The type of the conductive agent in the negative electrode material layer is not particularly limited in this application, provided that the objectives of this application can be achieved. For example, the conductive agent may include but is not limited to at least one of conductive carbon black (Super P), carbon nanotubes (CNTs), carbon fibers, flake graphite, Ketjen black, graphene, metal materials, or conductive polymers. The carbon nanotubes may include but are not limited to single-walled carbon nanotubes and/or multi-walled carbon nanotubes. The carbon fibers may include but are not limited to vapor grown carbon fibers (VGCF) and/or carbon nanofibers. The metal materials may include but are not limited to metal powder and/or metal fibers, and specifically, the metal may include but is not limited to at least one of copper, nickel, aluminum, or silver. The conductive polymers may include but are not limited to at least one of polyphenylene derivative, polyaniline, polythiophene, polyacetylene, or polypyrrole. The dispersant includes but is not limited to at least one of carboxymethyl cellulose or carboxymethyl cellulose sodium.

The preparation method of negative electrode is not particularly limited in this application, provided that the objectives of this application can be achieved. For example, the preparation method of negative electrode includes but is not limited to the following steps: (1) mixing a negative electrode active material with a solid electrolyte material to uniformity to obtain a mixture, then mixing the mixture with a negative electrode binder, a conductive agent, and a dispersant based on a specific mass ratio, adding a solvent, and then stirring them to uniformity to prepare a negative electrode slurry; (2) applying the negative electrode slurry to one surface of the negative electrode current collector, followed by drying to form a negative electrode material layer on one surface of the negative electrode current collector; (3) applying the negative electrode slurry to another surface of the negative electrode current collector, followed by drying to form a negative electrode material layer on each of two surfaces of the negative electrode current collector; and (4) carrying out cold-pressing and cutting to obtain a negative electrode. The external condition for mixing the negative electrode active material with the solid electrolyte material is not particularly limited in this application, provided that the objectives of this application can be achieved. For example, the ambient temperature during mixing is 15° C. to 40° C., and the ambient humidity during mixing is 30% to 70%. The rotation speed and time for mixing the negative electrode active material with the solid electrolyte material are not particularly limited in this application, provided that the objectives of this application can be achieved. For example, the revolution speed of the stirrer is 10 rpm to 40 rpm, the self-rotation speed of the stirrer is 200 rpm to 400 rpm, and the stirring time is 20 minutes to 1 hour. The mass ratio of a mixture of the negative electrode active material with the solid electrolyte material, the negative electrode binder, the conductive agent, and the dispersant is not particularly limited in this application, and those skilled in the art can make selection according to actual needs, provided that the objective of this application can be achieved. The solvent in the negative electrode slurry is not particularly limited in this application, provided that the objectives of this application can be achieved. For example, the solvent may be deionized water. The external conditions for mixing the mixture, the negative electrode binder, the conductive agent, and the dispersant is not particularly limited in this application, provided that the objective of this application can be achieved. For example, the ambient temperature during mixing is 15° C. to 40° C., and the ambient humidity during mixing is 30% to 70%. The rotation speed and time for mixing the mixture, the negative electrode binder, the conductive agent, and the dispersant are not particularly limited in this application, provided that the objectives of this application can be achieved. For example, the revolution speed of the stirrer is 10 rpm to 40 rpm, the self-rotation speed of the stirrer is 1500 rpm to 2000 rpm, and the stirring time is 20 minutes to 1 hour. The drying time and temperature are not particularly limited in this application, provided that the objectives of this application can be achieved.

In an embodiment of this application, the electrolyte solution includes a double bond compound. The double bond compound includes a compound A. The compound A includes at least one selected from the group consisting of ethylene carbonate (EC) and propylene carbonate, and based on a mass of the electrolyte solution, a mass percentage of the compound A is 15% to 80%. For example, the mass percentage of the compound A is 15%, 18%, 20%, 23%, 27%, 30%, 33%, 37%, 40%, 43%, 47%, 50%, 53%, 57%, 60%, 63%, 67%, 70%, 73%, 77%, or 80%, or a range defined by any two of foregoing values. With the use of foregoing type of compound A and its mass percentage being controlled within the foregoing range, it is conducive to catalyzing the solid electrolyte material for in-situ reactions, thereby controlling the percentages of the cycled products Li₂O, Li_{0.5}TiO₂, Li₃P, and Li₃PO₄ to be within an appropriate range, and the cycled products are fully utilized as electron/ion conductors to lower the impedance of the secondary battery. Therefore, the secondary battery has good rate performance and cycling performance.

In an embodiment of this application, the electrolyte solution includes a double bond compound. The double bond compound includes a compound B. The compound B includes at least one selected from the group consisting of vinylene carbonate and fluoroethylene carbonate (FEC), and based on the mass of the electrolyte solution, a mass percentage of the compound B is 1.5% to 12.5%. For example, the mass percentage of the compound B is 1.5%, 2%, 4%, 5%, 7%, 10%, 12%, or 12.5%, or a range defined by any two of foregoing values. With the use of foregoing type of compound B and its mass percentage being controlled within the foregoing range, it is conducive to catalyzing the solid electrolyte material for in-situ reactions, thereby controlling the percentages of the cycled products Li₂O, Li_{0.5}TiO₂, Li₃P, and Li₃PO₄ to be within an appropriate range, and the cycled products are fully utilized as electron/ion conductors to lower the impedance of the secondary battery. Therefore, the secondary battery has good rate performance and cycling performance.

In an embodiment of this application, the electrolyte solution further includes a lithium salt and a non-aqueous solvent in addition to the double bond compound. The lithium salt may include at least one of LiPF₆, LiNO₃, LiBF₄, LiCIO₄, LiB(C₆H₅)₄, LiCH₃SO₃, LiCF₃SO₃, LiCF₃SO₃, LIN (SO₂CF₃)₂, LiC(SO₂CF₃)₃, Li₂SiF₆, lithium difluoroacetate borate (LiDFOB), lithium bistrifluoromethanesulfonimide (LiTFSI), or lithium difluoroborate. Based the mass of the electrolyte solution, a mass percentage of the lithium salt is 5.8% to 65%. The non-aqueous solvent is not particularly limited in this application, provided that the objectives of this application can be achieved. For example, the non-aqueous solvent may include but is not limited to at least one of carbonate compounds, carboxylate compounds, ether compounds, or other organic solvents. The carbonate compounds may include but are not limited to at least one of linear carbonate compounds, cyclic carbonate compounds, or fluorocarbonate compounds. The linear carbonate compounds may include but are not limited to at least one of dimethyl carbonate, diethyl carbonate, dipropyl carbonate, methyl propyl carbonate, ethylene propyl carbonate, or methyl ethyl carbonate. The cyclic carbonates may include but are not limited to at least one of butylene carbonate or vinyl ethylene carbonate. The fluorocarbonate compounds may be but are not limited to at least one of 1,2-difluoroethylene carbonate, 1,1-difluoroethylene carbonate, 1,1,2-tricarbonate fluoroethylene, 1,1,2,2-tetrafluoroethylene carbonate, 1-fluoro-2-methylethylene carbonate, 1-fluoro-1-methylethylene carbonate, carbonic acid 1,2-Difluoro-1-methylethylene, 1,1,2-trifluoro-2-methylethylene carbonate, or trifluoromethylethylene carbonate. The carboxylate compounds may include but are not limited to at least one of methyl formate, methyl acetate, ethyl acetate, n-propyl acetate, tert-butyl acetate, methyl propionate, ethyl propionate, propyl propionate, γ-butyrolactone, decanolide, valerolactone, or caprolactone. The ether compounds may include but are not limited to at least one of dibutyl ether, tetraethylene glycol dimethyl ether, diglyme, 1,2-dimethoxyethane, 1,2-diethoxyethane, 1-ethoxy-1-methoxyethane, 2-methyltetrahydrofuran, or tetrahydrofuran. The other organic solvents may include but are not limited to at least one of dimethyl sulfoxide, 1,2-dioxolane, sulfolane, methyl sulfolane, 1,3-dimethyl-2-imidazolidinone, N-methyl-2-pyrrolidone, dimethylformamide, acetonitrile, trimethyl phosphate, triethyl phosphate, or trioctyl phosphate. The mass percentage of the non-aqueous solvent is not particularly limited in this application, provided that the objectives of this application can be achieved. For example, based on the mass of the electrolyte solution, a mass percentage of the non-aqueous solvent is 0% to 94.2%.

In an embodiment of this application, the electrolyte solution may include a lithium salt and a non-aqueous solvent, the mass percentage of the lithium salt is as described above, and the mass percentage of the non-aqueous solvent is 35% to 94.2%. The secondary battery including the foregoing electrolyte solution has good rate performance and cycling performance.

In an embodiment of this application, the electrolyte solution may include a lithium salt, a compound A, and a non-aqueous solvent, the mass percentages of the lithium salt and the compound A are as described above, and the mass percentage of the non-aqueous solvent is 0% to 79.2%. The secondary battery including the foregoing electrolyte solution has good rate performance and cycling performance.

In an embodiment of this application, the electrolyte solution may include a lithium salt, a compound B, and a non-aqueous solvent, the mass percentages of the lithium salt and the compound B are as described above, and the mass percentage of the non-aqueous solvent is 22.5% to 92.7%. The secondary battery including the foregoing electrolyte solution has good rate performance and cycling performance.

In an embodiment of this application, the electrolyte solution may include a lithium salt, a compound A, a compound B, and a non-aqueous solvent, the mass percentages of the lithium salt, the compound A, and the compound B are as described above, and the mass percentage of the non-aqueous solvent is 0% to 77.7%. The secondary battery including the foregoing electrolyte solution has good rate performance and cycling performance.

In this application, the secondary battery includes a positive electrode, and the positive electrode is not particularly limited in this application, provided that the objectives of this application can be achieved. For example, the positive electrode includes a positive electrode current collector and a positive electrode material layer disposed on at least one surface of the positive electrode current collector. The “positive electrode material layer disposed on at least one surface of the positive electrode current collector” means that the positive electrode material layer may be disposed on one surface or two surfaces of the positive electrode current collector in its thickness direction. It should be noted that the “surface” herein may be an entire region or a partial region of the surface of the positive electrode current collector. This is not particularly limited in this application, provided that the objectives of this application can be achieved. The positive electrode current collector is not particularly limited in this application, provided that the objectives of this application can be achieved. For example, the positive electrode current collector may include aluminum foil, aluminum alloy foil, a composite current collector (such as an aluminum-carbon composite current collector), or the like. The positive electrode material layer of this application includes a positive electrode active material. The type of the positive electrode active material is not particularly limited in this application, provided that the objectives of this application can be achieved. For example, the positive electrode active material may include at least one of lithium nickel cobalt manganate (NCM811, NCM622, NCM523, NCM111), lithium nickel cobalt aluminate, lithium iron phosphate, lithium-rich manganese-based material, lithium cobalt oxide (LiCoO₂), lithium manganate, lithium iron manganese phosphate, lithium titanate, or the like. In this application, the positive electrode active material may further include a non-metal element. For example, the non-metal element includes at least one of fluorine, phosphorus, boron, chlorine, silicon, or sulfur. Thicknesses of the positive electrode current collector and the positive electrode material layer are not particularly limited in this application, provided that the objective of this application can be achieved. For example, the thickness of the positive electrode current collector is 5 μm to 20 μm, preferably 6 μm to 18 μm. The thickness of the positive electrode material layer on a single surface is 30 μm to 120 μm. In this application, the positive electrode material layer may further include a conductive agent and a positive electrode binder. The type of the positive electrode binder in the positive electrode material layer is not particularly limited in this application, provided that the objectives of this application can be achieved. For example, the positive electrode binder may be of the same type as the negative electrode binder in the negative electrode material layer described above. The type of the conductive agent in the positive electrode material layer is not particularly limited in this application, provided that the objectives of this application can be achieved. For example, the conductive agent may be of the same type as the conductive agent in the negative electrode material layer described above. A mass ratio of the positive electrode active material, the conductive agent, and the positive electrode binder in the positive electrode material layer is not particularly limited in this application, and persons skilled in the art can make selection based on actual needs, provided that the objectives of this application can be achieved.

The separator is not particularly limited in this application, provided that the objectives of this application can be achieved. For example, the material of the separator may include but is not limited to at least one of polyolefin (PO) such as polyethylene (PE) or polypropylene (PP), polyester (for example, polyethylene terephthalate (PET) film), cellulose, polyimide (PI), polyamide (PA), spandex, or aramid. The type of the separator may include at least one of a woven film, a nonwoven film, a microporous film, a composite film, a rolling film, or a spinning film. The separator of this application can have a porous structure, and the pore size of the porous structure of the separator is not particularly limited in this application, provided that the of objectives porous structure of this application can be achieved. For example, the pore size may be 0.01 μm to 1 μm. The thickness of the separator is not particularly limited this application, provided that the objectives of this application can be achieved. For example, the thickness of the separator may be 5 μm to 500 μm.

The secondary battery of this application further includes a packaging bag for accommodating the positive electrode plate, the negative electrode plate, the separator, the electrolyte solution, and other known components of the secondary battery in the art. The other components are not limited in this application. The packaging bag is not particularly limited in this application and may be any well-known packaging bag in the art, provided that the objectives of this application can be achieved.

The secondary battery in this application is not particularly limited and may include any apparatus in which electrochemical reactions take place. In an embodiment of this application, the secondary battery may include but is not limited to a lithium-ion secondary battery (a lithium-ion battery), a lithium polymer secondary battery, or a lithium-ion polymer secondary battery.

The preparation method of secondary battery is not particularly limited in this application, and any well-known preparation method in the art can be used, provided that the objectives of this application can be achieved. For example, the preparation method of secondary battery includes but is not limited to the following steps: stacking a positive electrode, a separator, and a negative electrode in sequence, followed by operations such as winding and folding as needed to obtain an electrode assembly with a wound structure, placing the electrode assembly into a packaging bag, injecting an electrolyte solution into the packaging bag, and sealing the packaging bag to obtain a secondary battery; or stacking a positive electrode, a separator, and a negative electrode in sequence, fixing four corners of an entire stacked structure to obtain an electrode assembly with a stacked structure, placing the electrode assembly into a packaging bag, injecting an electrolyte solution into the packaging bag and sealing the packaging bag to obtain a secondary battery.

A second aspect of this application provides an electronic apparatus including the secondary battery according to any one of the foregoing embodiments. The secondary battery provided in this application has good rate performance, lithium precipitation performance, and cycling performance, so the electronic apparatus of this application has a longer service life.

The electronic apparatus of this application is not particularly limited and may be any known electronic apparatus used in the prior art. For example, the electronic apparatus may include but is not limited to a notebook computer, a pen-input computer, a mobile computer, an electronic book player, a portable telephone, a portable fax machine, a portable copier, a portable printer, a stereo headset, a video recorder, a liquid crystal television, a portable cleaner, a portable CD player, a mini-disc, a transceiver, an electronic notepad, a calculator, a storage card, a portable recorder, a radio, a standby power source, a motor, an automobile, a motorcycle, a power-assisted bicycle, a bicycle, a lighting appliance, a toy, a game console, a clock, an electric tool, a flash lamp, a camera, a large household battery, and a lithium-ion capacitor.

### EXAMPLE

In the following, examples and comparative examples are given to describe some embodiments of this application in more detail. Various tests and evaluations are performed in the following methods.

### Test Methods and Devices

### Method for Sampling Negative Electrode and Negative Electrode Active Material

At an ambient temperature of 25° C., a lithium-ion battery was disassembled to take out a negative electrode, the negative electrode was soaked in dimethyl carbonate (DMC) for 20 minutes, then the negative electrode was placed into an oven and dried at 80° C. for 12 hours to obtain a negative electrode sample. The sampling method described above was used for all negative electrode samples in the following tests: scanning electron microscopy test, element analysis test, X-ray photoelectron spectroscopy analysis, cyclic voltammetry test, test for ionic conductivity of negative electrode, test for resistance per unit area of negative electrode, test for coating weight of negative electrode material layer, test for porosity of negative electrode material layer, and test for average particle size of negative electrode active material.

Test for Mass Percentages of Li₂O, Li_{0.5}TiO₂, Li₃P, and Li₃PO₄

At an ambient temperature of 25° C., a lithium-ion battery was charged to 4.45 V at a constant current of 0.02 C, charged to 0.025 C at a constant voltage of 4.45 V, left standing for 5 minutes, and discharged to 3.0 V at 0.5 C. After 500 cycles of the charging and discharging process, the lithium-ion battery was disassembled to take out a negative electrode, the negative electrode was soaked in dimethyl carbonate (DMC) for 20 minutes, then the negative electrode was placed into an oven and dried at 80° C. for 12 hours to obtain a negative electrode sample. The negative electrode material layer was scrapped from the negative electrode current collector of the negative electrode sample to obtain a powder. The powder sample was pressed into a block sample with a flat surface, and XPS test was performed on the block sample according to the national standard GBT33502-2017. An area of each peak was calculated using XPS peak fitting to obtain mass percentages of Li₂O, Li_{0.5}TiO₂, Li₃P, and Li₃PO₄.

### Scanning Electron Microscopy Test:

Ion polishing was performed on the negative electrode sample to obtain a cross-section of the negative electrode sample. A Philips XL-30 field emission scanning electron microscope was used for testing under the conditions of 10 kV and 10 mA. Silicon particles and graphite particles were distinguished and counted using a backscatter mode. The silicon particle regions were brighter, and the graphite particle regions were darker.

### Element Analysis Test

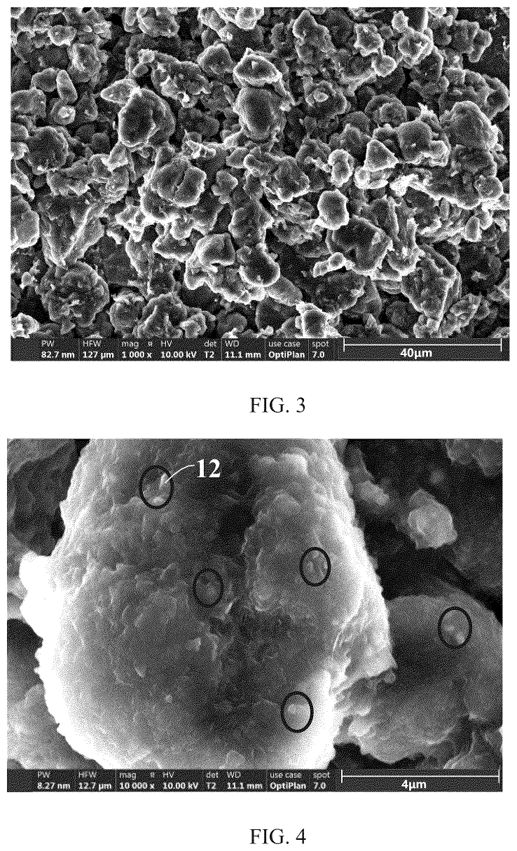

Ion polishing was performed on the negative electrode sample to obtain a cross-section of the negative electrode sample. An X-ray energy dispersive spectrometer (EDS) was used for element analysis test, surface mapping (mapping) and line mapping tests were performed on a cross-section of the negative electrode sample. For the line mapping test, reference may be made to a schematic test diagram of FIG. 4. Specifically, in FIG. 4, the horizontal coordinates in (b) to (e) represent the cross-sectional test distance of the negative electrode sample, with the starting and ending points corresponding to line segment Q in (a) of FIG. 4. Based on the EDS mapping test, cross-sectional element distribution of the negative electrode sample can be observed. Based on the EDS line mapping results, the change in the percentage of element at each point on line segment Q can be observed.

The negative electrode material layer was scrapped from the negative electrode current collector of the negative electrode sample to obtain a powder sample. 0.1 g of the powder sample was weighed and placed into a digestion tank; 10 mL of aqua regia digestion reagent was added into the tank; the tank was shaken for 30 minutes for digestion; the sample digested was poured into a volumetric flask and diluted to 150 mL with deionized water; and an inductively coupled plasma optical emission spectrometer (ICP-OES, model Agilent 5800) was used to test the sample against a standard sample according to the US Environmental Protection Agency (EPA) standards EPA 3052-1996 and EPA 6010D-2014 to obtain concentrations of elements Al, Ti, and P. The mass percentage of aluminum in the negative electrode material layer is A %, A %=(concentration of aluminum×constant volume)/mass of powder sample×100%. The mass percentage of titanium in the negative electrode material layer is B %, B %=(concentration of titanium×constant volume)/mass of powder sample×100%. The mass percentage of phosphorus in the negative electrode material layer is C %, C %=(concentration of phosphorus×constant volume)/mass of powder sample×100%.

### X-Ray Photoelectron Spectroscopy Analysis

X-ray photoelectron spectroscopy (XPS) was used to test a negative electrode material layer (target material: Al). The negative electrode material layer was scrapped from the negative electrode current collector of the negative electrode sample to obtain a powder. The powder sample was pressed into a block sample with a flat surface, and XPS test was performed on the block sample according to the national standard GBT33502-2017. The characteristic peaks corresponding to the peaks of 458±2 eV and 464±2 eV were the first characteristic peaks, and the characteristic peak corresponding to the peak of 460±2 eV was the second characteristic peak. A peak area of the first characteristic peaks was obtained as a by integrating the peaks of 458±2 eV and 464±2 eV, and a peak area of the second characteristic peak was obtained as b by integrating the peaks of 460±2 eV, so that the value of a/b is obtained.

### Cyclic Voltammetry Test

A negative electrode sample was used as the working electrode and a lithium sheet was used as the counter electrode, a separator was placed between the negative electrode sample and the lithium sheet for separation, an electrolyte solution was injected, and assembling was performed to obtain a button cell. Linear scanning on the button cell voltage was performed at a speed of 0.1 mV/s within a voltage range of 0 V to 3 V to obtain a current-voltage curve. The separator and electrolyte solution used in the test were the same as those in Example 1-1.

### Test for Ionic Conductivity of Negative Electrode

A negative electrode sample was used as the working electrode and a lithium sheet was used as the counter electrode, a separator was placed between the negative electrode sample and the lithium sheet for separation, an electrolyte solution was injected, and assembling was performed to obtain a button cell. An electrochemical workstation Solartron 1260A was used to test the button cell. The electrochemical impedance spectroscopy (EIS) of the lithium-ion battery was tested within a frequency range of 5 MHz to 1000 kHz, with a perturbation voltage of 5 mV, and a test temperature of 25° C.; and calculation was performed to obtain the ionic conductivity of the negative electrode under test. The separator and electrolyte solution used in the test were the same as those in Example 1-1.

### Test for Resistance Per Unit Area of Negative Electrode

A resistivity tester (Suzhou Jingge Electronics ST-2255A) was used for testing. The resistance and pressure of the resistivity tester were reset before use, a negative electrode sample under test was placed between electrodes of the tester, 12 sections of the negative electrode with an area of 5 cm×6 cm were selected from different positions of the negative electrode sample, and resistance values measured within the twelve 5 cm×6 cm areas were averaged by dividing by 12 to obtain a value of the resistance per unit area of the negative electrode sample under test.

### Test for Thickness of Carbon Material

A transmission electron microscope (TEM) was used to test the thickness of a carbon material on the surface of solid electrolyte material particles. The negative electrode material layer was scrapped from the negative electrode current collector of the negative electrode sample to obtain a powder. The powder was dispersed in ethanol to prepare a sample, and the prepared sample was observed using the TEM, with lattice fringes corresponding to the solid electrolyte material and a surface amorphous structure corresponding to the carbon material. 10 solid electrolyte materials were randomly selected, the carbon material thickness on their respective surfaces was measured, and an average value was taken from the thicknesses as the thickness of the carbon material on the surface of solid electrolyte material particles.

### Test for Average Particle Size of Negative Electrode Active Material

A scanning electron microscope (SEM) was used to test the average particle size of the negative electrode active material. Equivalent diameters of 10 negative electrode active material particles were randomly selected and measured, and an average value was taken from the diameters as the average particle size of the negative electrode active material under test. In this application, the average particle size can be understood as the equivalent diameter. The equivalent diameter generally refers to a diameter of a sphere with the same volume as an irregularly shaped object. An area of negative electrode active material particles under test on the surface of the negative electrode plate is measured, and then a diameter of a circle with the same area is used as the equivalent diameter of the negative electrode active material particles under test.

### Coating Weight of Negative Electrode Material Layer

A negative electrode in a unit area was cut from a negative electrode sample and weighed on a balance, with the weight denoted as q1, then the negative electrode material layer was scrapped off from the negative electrode, and the negative electrode current collector was weighed on the balance, with the weight denoted as q2.

For a negative electrode having the negative electrode material layer coated on a single surface, the coating weight of the negative electrode material layer is q1-q2.

For a negative electrode having the negative electrode material layer coated on two surfaces, the coating weight of the negative electrode material layer is (q1−q2)/2.

### Test for Porosity of Negative Electrode Material Layer

A negative electrode was die-cut into small discs with a diameter of 14 mm, thicknesses of the negative electrode at randomly selected 8 points were measured using a micrometer, and an average thickness of the 8 points was the thickness of the negative electrode sample. The small disc was placed into an Accupyc II1340 true density instrument for testing to obtain a true density V2, and then with the diameter, thickness, and mass of the small disc, an apparent density V1 was calculated. The porosity of the negative electrode material layer was (V1−V2)/V1×100%.

### Cycling Performance Test

At a test temperature of 25° C., lithium-ion batteries in the examples and comparative examples were charged to 4.45 V at a constant current of 1 C, and then charge to 0.025 C at a constant voltage of 4.45 V, left standing for 5 minutes, and discharged to 3.0 V at 0.5 C. The capacity obtained in this step was the initial capacity. The cycling test was performed according to the foregoing cycling process, the capacity of the lithium-ion battery was measured after each cycle, and with a ratio of the capacity of each cycle to the initial capacity, a capacity decay curve was obtained. A first discharge capacity was expressed as 100%, the charge and discharge cycle was repeated until the discharge capacity retention rate decayed to 80% of the first discharge capacity, then the test stopped, and the number of cycles was recorded.

### Rate Performance Test

At an ambient temperature of 25° C., the lithium-ion batteries in the examples and comparative examples were charged to 4.45 V at a constant current of 0.5 C, and then charged to 0.025 C at a constant voltage of 4.45 V, left standing for 5 minutes, then discharged to 3 V at 0.5 C, and a discharge capacity at 0.5 C was recorded. The lithium-ion batteries were left standing for 5 minutes, then charged again to 4.45 V at a constant current of 0.5 C, and charged at a constant voltage of 4.45 V until the current is 0.05 C, left standing for 5 minutes, then discharged to 3 V at 3 C, and a discharge capacity at 3 C was recorded. Discharge capacity retention rate at 3 C (%)=discharge capacity at 3 C/discharge capacity at 0.5 C×100%.

### Lithium Precipitation Test

The lithium-ion battery were placed in a 25° C. constant temperature chamber for 120 minutes, charged to 4.45 V at a constant current of 2 C, and then charged at a constant voltage of 4.45 V until the current is 0.025 C, left standing for 5 minutes, then discharged to 3.0 V at a constant current of 0.5 C. This was one cycle. After 100 cycles of the charging and discharging process, the lithium-ion batteries were charged again to 4.45 V at a constant current of 2 C, then disassembled, and observed for lithium precipitation on the surface of the negative electrode. A region on the surface of the negative electrode without lithium precipitation appears golden yellow, while a region on the surface of the negative electrode without lithium precipitation appears silver-white metallic. The part of the negative electrode for welding a tab is the head of the negative electrode, and the part other than the head of the negative electrode is the main body of the negative electrode.

The criteria for judging the degree of lithium precipitation in lithium-ion batteries are as follows: a lithium precipitation area of 0% means no lithium precipitation, a lithium precipitation area less than or equal to 2% means slight lithium precipitation, a lithium precipitation area of 2% to 10% means moderate lithium precipitation, and a lithium precipitation area greater than 10% means severe lithium precipitation. The percentage of the lithium precipitation area is calculated based on the total area of the negative electrode material layer.

### Example 1-1

### <Preparation of Negative Electrode>

A mixture of negative electrode active materials artificial graphite and silicon was mixed with solid electrolyte material Li_{1.3}Al_{0.3}Ti_{1.7} (PO₄)₃ at a room temperature of 25° C. and an ambient humidity of 40% to 45%, then stirred at a revolution speed of 20 rpm and a self-rotation speed of 300 rpm for 30 minutes to obtain a first mixture. Then the first mixture was mixed with negative electrode binder styrene-butadiene rubber, conductive agent conductive carbon black, and dispersant sodium carboxymethyl cellulose at a mass ratio of 96:3:0.5:0.5, the order of addition was conductive carbon black, the dispersant sodium carboxymethyl cellulose, the first mixture, styrene-butadiene rubber, and deionized water, and the ambient requirements were room temperature of 25° C. and ambient humidity of 40% to 45%. After mixing, a resulting mixture was stirred at a revolution speed of 30 rpm and a self-rotation speed of 1800 rpm for 40 minutes to obtain a negative electrode slurry with a solid content of 70 wt %. The negative electrode slurry was uniformly applied on one surface of a negative electrode current collector copper foil with a thickness of 6 μm and dried at 120° C., to obtain a negative electrode having a negative electrode material layer coated on a single surface with a coating weight CW of 8 mg/cm². Then the foregoing operation steps were repeated on the other surface of the negative electrode current collector copper foil to obtain a negative electrode having a negative electrode material layer coated on two surfaces. The coated negative electrode was cold-pressed with a cold-pressing pressure of 3t to obtain a negative electrode with a compacted density of 1.7 g/cm³. Then the negative electrode was cut in dimensions of 74 mm×800 mm for later use. The mass ratio of artificial graphite and silicon in the negative electrode active material was 1:1. Based on a mass of the negative electrode material layer, the mass percentage Y of the solid electrolyte material was 2%, the mass percentage A of aluminum was 0.042%, the mass percentage B of titanium was 0.425%, and the mass percentage C of phosphoruswas 0.485%. The average particle size of the negative electrode active material through crushing and shaping was 10 μm, and the porosity φ of the negative electrode material layer was 25%.

### <Preparation of Positive Electrode>

Positive electrode active substance lithium cobaltate (LiCoO₂), conductive agent Super P, and binder polyvinylidene fluoride (PVDF) at a mass ratio of 97:1.4:1.6 were dispersed in solvent N-methylpyrrolidone (NMP) and fully stirred and mixed to obtain a positive electrode slurry with a solid content of 72 wt %. The positive electrode slurry was uniformly applied onto one surface of a positive electrode current collector aluminum foil with a thickness of 8 μm and dried at 85° C. to obtain a positive electrode having a positive electrode material layer coated on a single surface with a coating weight of 12 mg/cm². Then, the foregoing steps were repeated on another surface of the positive electrode current collector aluminum foil to obtain a positive electrode having the positive electrode material layer coated on two surfaces. After cold pressing, cutting, and slitting, drying was performed in vacuum at 85° C. for 4 hours to obtain positive electrodes with a dimension of 72 mm×792 mm for later use. The cold pressing pressure was 3t.

### <Preparation of Separator>

The polyethylene (PE) porous polymer film with a thickness of 7 μm was used as a separator.

### <Preparation of Electrolyte Solution>

In a dry argon atmosphere glove box, the compound A ethylene carbonate (EC), the compound B fluoroethylene carbonate (FEC), and the non-aqueous solvent diethyl carbonate (DEC) were mixed to obtain a base solvent, then lithium salt lithium hexafluorophosphate (LiPF₆) was added to the base solvent and fully mixed to uniformity to obtain an electrolyte solution. Based on a mass of the electrolyte solution, a mass percentage of the lithium salt was 23%, a mass percentage of the compound A was 44%, a mass percentage of the compound B was 10%, and the remainder was the non-aqueous solvent.

### <Preparation of Lithium-Ion Battery>

The prepared positive electrode, separator, and negative electrode were stacked in sequence, so that the separator was placed between the positive electrode and the negative electrode for separation. A thus formed stack was wound and welded with tabs, and then placed in an outer packaging foil aluminum plastic film. Then the prepared electrolyte solution was injected, followed by processes such as vacuum packaging, standing, formation, degassing, and slitting, to obtain a lithium-ion battery. The formation step was as follows: At an ambient temperature of 25° C., a lithium-ion battery was charged to 4.45 V at a constant current of 0.5 C, charged to 0.025° C. at a constant voltage of 4.45 V, left standing for 5 minutes, and discharged to 3.0 V at 0.5 C. The liquid injection coefficient of the electrolyte solution was 2.2 g/Ah.

### Examples 1-2 to 1-16

These examples were the same as Example 1-1 except that the related parameters were adjusted according to Table 1. When the mass percentage Y of the solid electrolyte material changes, the mass percentage of the negative electrode active material changes accordingly, and the mass percentages of the negative electrode binder, conductive agent, and dispersant remain unchanged. The mass ratio of artificial graphite to silicon in the negative electrode active material remains unchanged. The solid electrolyte materials in Examples 1-14 to 1-16 were Li_{1.3}Al_{0.3}Sn_{0.1}Ti_{1.6} (PO₄)₃, Li_{1.3} Al_{0.3}Ge_{0.1} Ti_{1.6} (PO₄)₃, and Li_{1.3}Al_{0.3}Si_{0.1}Ti_{1.6} (PO₄)₃, respectively.

### Example 2-1

This example was the same as Example 1-1 except that the solid electrolyte material was prepared using steps below.

<Preparation of Solid Electrolyte Material with Carbon Material on Particle Surface>

A chemical vapor deposition (CVD) method was used for preparation. Solid electrolyte material Li_{1.3}Al_{0.3} Ti_{1.7} (PO₄)₃ was uniformly dispersed in a tube furnace, and with the introduction of acetylene gas, calcined at a calcination temperature of 700° C. for 2 hours to obtain solid electrolyte material Li_{1.3}Al_{0.3} Ti_{1.7} (PO₄)₃ with carbon material on the particle surface.

### Examples 2-2 to 2-4

These examples were the same as Example 2-1 except that the related parameters were adjusted according to Table 4. When the thickness of the carbon material changes, the calcination temperature and calcination time were adjusted to make the thickness of the carbon material as shown in Table 4.

### Examples 2-5 to 2-7

These examples were the same as Example 1-1 except that the related parameters were adjusted according to Table 4. When the average particle size of the negative electrode active material changed, times for crushing and shaping were adjusted so that the average particle size of the negative electrode active material were as shown in Table 4.

### Examples 2-8 to 2-9

These examples were the same as Example 1-1 except that the related parameters were adjusted according to Table 4. When the porosity φ of the negative electrode material layer changed, the cold pressing pressure was adjusted to make the porosity φ of the negative electrode material layer as shown in Table 4.

### Examples 2-10 to 2-13

These examples were the same as Example 1-1 except that the related parameters were adjusted according to Table 4. When the coating weight CW of the negative electrode material layer changed, the coating amount of the negative electrode slurry was adjusted to make the coating weight CW of the negative electrode material layer as shown in Table 4.

### Examples 2-14 to 2-15

These examples were the same as Example 1-1 except that the related parameters were adjusted according to Table 4.

### Examples 3-1 to 3-11

These examples were the same as Example 1-1 except that the related parameters were adjusted according to Table 5. When the percentage of the sulfur-oxygen double bond-containing compound changed, the mass percentage of the non-aqueous solvent changed accordingly, and the mass percentage of the lithium salt remained unchanged.

### Comparative Examples 1 and 2

These comparative examples were the same as Example 1-1 except that the related parameters were adjusted according to Table 1.

### Comparative Example 3

This comparative example was the same as Example 1-1 except that the negative electrode was prepared using steps below.

### <Preparation of Negative Electrode>

A mixture of negative electrode active materials artificial graphite and silicon, the negative electrode binder styrene-butadiene rubber, the conductive agent conductive carbon black, and the dispersant sodium carboxymethyl cellulose were mixed at a mass ratio of 96:3:0.5:0.5, added with deionized water as a solvent, and after the addition, at a room temperature of 25° C. and an ambient humidity of 40% to 45%, a resulting mixture was stirred at a revolution speed of 30 rpm and a self-rotation speed of 1800 rpm for 40 minutes to obtain a negative electrode slurry with a solid content of 70 wt %. The negative electrode slurry was uniformly applied on one surface of a negative electrode current collector copper foil with a thickness of 6 μm and dried at 120° C., to obtain a negative electrode having a negative electrode material layer coated on a single surface with a coating weight CW of 8 mg/cm². Then the foregoing operation steps were repeated on the other surface of the negative electrode current collector copper foil to obtain a negative electrode having a negative electrode material layer coated on two surfaces. The coated negative electrode was cold-pressed with a cold-pressing pressure of 3t to obtain a negative electrode with a compacted density of 1.7 g/cm³. Then the negative electrode was cut in dimensions of 74 mm×800 mm for later use. The mass ratio of artificial graphite and silicon in the negative electrode active material was 1:1, the average particle size of the negative electrode active material was 10 μm, and the porosity φ of the negative electrode material layer was 25%.

The related parameters and performance test results of examples and comparative examples are shown in Table 1 to Table 5.

TABLE 1

| | | | | | Doping | Y | D | | | |
|---|---|---|---|---|---|---|---|---|---|---|
| | A (%) | B (%) | C (%) | x | element | (%) | (%) | E (%) | F (%) | G (%) |
| Example 1- | 0.042 | 0.425 | 0.485 | 0.3 | / | 2 | 0.16 | 0.21 | 0.08 | 0.15 |
| 1 | | | | | | | | | | |
| Example 1- | 0.004 | 0.488 | 0.480 | 0.0 | / | 2 | 0.13 | 0.28 | 0.08 | 0.14 |
| 2 | | | | 3 | | | | | | |
| Example 1- | 0.007 | 0.483 | 0.480 | 0.0 | / | 2 | 0.13 | 0.26 | 0.07 | 0.14 |
| 3 | | | | 5 | | | | | | |
| Example 1- | 0.014 | 0.472 | 0.481 | 0.1 | / | 2 | 0.14 | 0.25 | 0.07 | 0.15 |
| 4 | | | | | | | | | | |
| Example 1- | 0.0284 | 0.449 | 0.483 | 0.2 | / | 2 | 0.15 | 0.23 | 0.09 | 0.17 |
| 5 | | | | | | | | | | |
| Example 1- | 0.0564 | 0.402 | 0.486 | 0.4 | / | 2 | 0.17 | 0.19 | 0.08 | 0.18 |
| 6 | | | | | | | | | | |
| Example 1- | 0.071 | 0.378 | 0.488 | 0.5 | / | 2 | 0.18 | 0.18 | 0.09 | 0.19 |
| 7 | | | | | | | | | | |
| Example 1- | 0.0044 | 0.0446 | 0.0506 | 0.3 | / | 0.2 | 0.02 | 0.017 | 0.01 | 0.018 |
| 8 | | | | | | | | | | |
| Example 1- | 0.005 | 0.0558 | 0.0633 | 0.3 | / | 0.25 | 0.023 | 0.019 | 0.011 | 0.024 |
| 9 | | | | | | | | | | |
| Example 1- | 0.0616 | 0.6244 | 0.7084 | 0.3 | / | 2.8 | 0.20 | 0.34 | 0.105 | 0.223 |
| 10 | | | | | | | | | | |
| Example 1- | 0.2156 | 2.19 | 2.48 | 0.3 | / | 9.8 | 0.54 | 1.01 | 0.45 | 1.08 |
| 11 | | | | | | | | | | |
| Example 1- | 0.0022 | 0.0223 | 0.0253 | 0.3 | / | 0.1 | 0.011 | 0.0089 | 0.0046 | 0.0103 |
| 12 | | | | | | | | | | |
| Example 1- | 0.224 | 2.27 | 2.58 | 0.3 | / | 10.2 | 0.55 | 1.12 | 0.46 | 1.11 |
| 13 | | | | | | | | | | |
| Example 1- | 0.0434 | 0.411 | 0.4978 | 0.3 | Sn | 2 | 0.132 | 0.149 | 0.086 | 0.196 |
| 14 | | | | | | | | | | |
| Example 1- | 0.0438 | 0.4162 | 0.5102 | 0.3 | Ge | 2 | 0.138 | 0.157 | 0.088 | 0.199 |
| 15 | | | | | | | | | | |
| Example 1- | 0.0444 | 0.4212 | 0.51 | 0.3 | Si | 2 | 0.129 | 0.164 | 0.088 | 0.201 |
| 16 | | | | | | | | | | |
| Comparative | 0.0011 | 0.01115 | 0.01265 | 0.3 | / | 0.05 | 0.018 | 0.0082 | 0.0032 | 0.0053 |
| example 1 | | | | | | | | | | |
| Comparative | 0.264 | 2.676 | 3.036 | 0.3 | / | 12 | 0.58 | 1.245 | 0.812 | 1.616 |
| example 2 | | | | | | | | | | |
| Comparative | / | / | / | / | / | / | 0.05 | / | / | / |
| example 3 | | | | | | | | | | |

Note:
“/” in Table 1 means that a related preparation parameter does not exist.

TABLE 2

| | | | Discharge | | |
|---|---|---|---|---|---|
| | | | capacity | Number | |
| | | | retention | of | Lithium |
| | | R | rate at 3 C | cycles | precipitation |
| | κ (S/cm) | (Ω/cm²) | (%) | (cls) | state |
| Example | 3.4 × 10⁻⁴ | 0.118 | 93.2 | 888 | No lithium |
| 1-1 | | | | | precipitation |
| Example | 2.1 × 10⁻⁴ | 0.119 | 92.6 | 867 | No lithium |
| 1-2 | | | | | precipitation |
| Example | 2.4 × 10⁻⁴ | 0.121 | 92.5 | 869 | No lithium |
| 1-3 | | | | | precipitation |
| Example | 2. × 10⁻⁴ | 0.117 | 92.8 | 874 | No lithium |
| 1-4 | | | | | precipitation |
| Example | 2.8 × 10⁻⁴ | 0.114 | 93.1 | 889 | No lithium |
| 1-5 | | | | | precipitation |
| Example | 3.5 × 10⁻⁴ | 0.111 | 93.3 | 891 | No lithium |
| 1-6 | | | | | precipitation |
| Example | 3.6 × 10⁻⁴ | 0.107 | 93.5 | 892 | No lithium |
| 1-7 | | | | | precipitation |
| Example | 3.41 × 10⁻⁴ | 0.105 | 93.12 | 885 | No lithium |
| 1-8 | | | | | precipitation |
| Example | 3.51 × 10⁻⁴ | 0.106 | 93.79 | 893 | No lithium |
| 1-9 | | | | | precipitation |
| Example | 3.89 × 10⁻⁴ | 0.129 | 93.9 | 894 | No lithium |
| 1-10 | | | | | precipitation |
| Example | 3.91 × 10⁻⁴ | 0.133 | 93.78 | 890 | No lithium |
| 1-11 | | | | | precipitation |
| Example | 3.18 × 10⁻⁴ | 0.128 | 92.5 | 825 | Slight |
| 1-12 | | | | | lithium |
| | | | | | precipitation |
| | | | | | at head |
| Example | 3.21 × 10⁻⁴ | 0.130 | 92.31 | 828 | Slight |
| 1-13 | | | | | lithium |
| | | | | | precipitation |
| | | | | | at head |
| Example | 3.4 × 10⁻⁴ | 0.112 | 93.3 | 883 | No lithium |
| 1-14 | | | | | precipitation |
| Example | 3.6 × 10⁻⁴ | 0.114 | 93.2 | 894 | No lithium |
| 1-15 | | | | | precipitation |
| Example | 3.52 × 10⁻⁴ | 0.113 | 92.9 | 889 | No lithium |
| 1-16 | | | | | precipitation |
| Comparative | 2.43 × 10⁻⁴ | 0.189 | 90.1 | 702 | Moderate |
| example 1 | | | | | lithium |
| | | | | | precipitation |
| | | | | | at head and |
| | | | | | main body |
| Comparative | 2.98 × 10⁻⁴ | 0.165 | 91.2 | 789 | Moderate |
| example 2 | | | | | lithium |
| | | | | | precipitation |
| | | | | | at head and |
| | | | | | main body |
| Comparative | 1.87 × 10⁻⁴ | 0.214 | 89.3 | 675 | Moderate |
| example 3 | | | | | lithium |
| | | | | | precipitation |
| | | | | | at head and |
| | | | | | main body |

It can be seen from Examples 1-1 to 1-16 and Comparative example 1 to 3 that the solid electrolyte material is added to the negative electrode material layer so that the mass percentages of Li₂O, Li_{0.5}TiO₂, Li₃P, and Li₃PO₄ are within the ranges in this application, thereby enhancing the ionic conductivity of the negative electrode plate, lowering the resistance per unit area of the negative electrode, increasing the discharge capacity retention rate at 3 C and the number of cycles, and improving the lithium precipitation state. This indicates that the lithium-ion battery of this application has good rate performance, lithium precipitation performance, and cycling performance. It can be seen from Examples 1-1 to 1-13 and Comparative examples 1 and 2 that when the mass percentages of Li₂O, Li_{0.5}TiO₂, Li₃P, and Li₃PO₄ are not within the ranges in this application, even if the solid electrolyte material is added to the negative electrode material layer, the ionic conductivity of the negative electrode is not significantly enhanced, the reduction in resistance per unit area of the negative electrode is less, the discharge capacity retention rate at 3 C is lower, the number of cycles is fewer, and the lithium precipitation state cannot be effectively improved. The obtained lithium-ion battery has poor rate performance, lithium precipitation performance, and cycling performance. It can be seen from Examples 1-1 to 1-13 and Comparative example 3 that when no solid electrolyte material is added to the negative electrode material layer, the ionic conductivity of the negative electrode is lower, the resistance per unit area of the negative electrode is higher, the discharge capacity retention rate at 3 C is lower, the number of cycles is fewer, and the lithium precipitation state is bad. The obtained lithium-ion battery has poor rate performance, lithium precipitation performance, and cycling performance. This thus indicates that the lithium-ion battery of this application has good rate performance, lithium precipitation performance, and cycling performance.

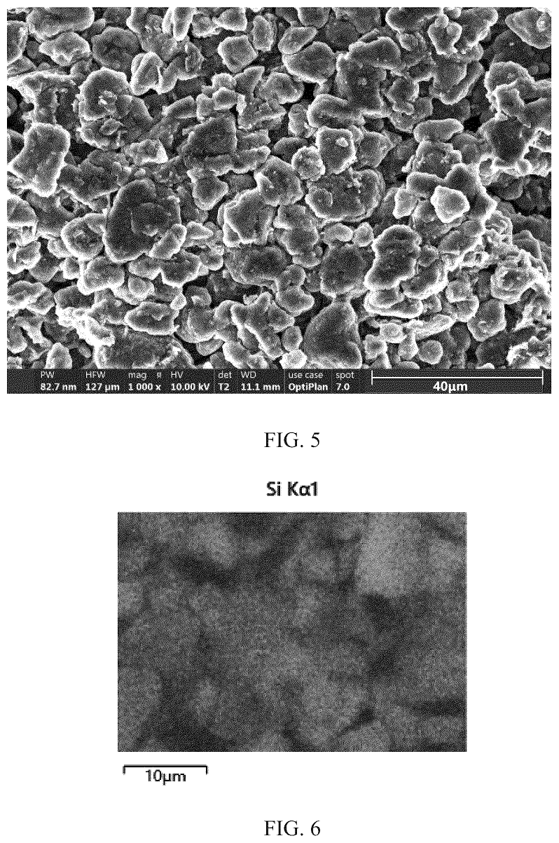

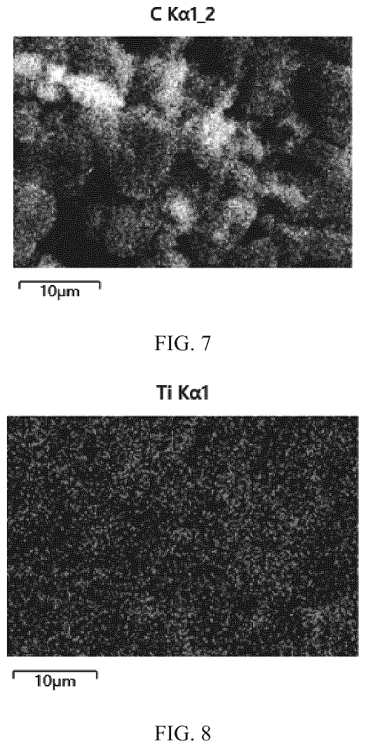

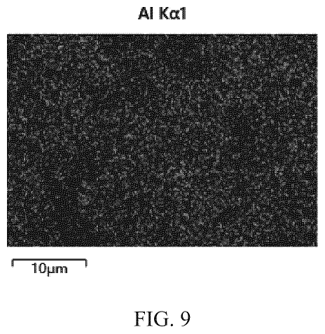

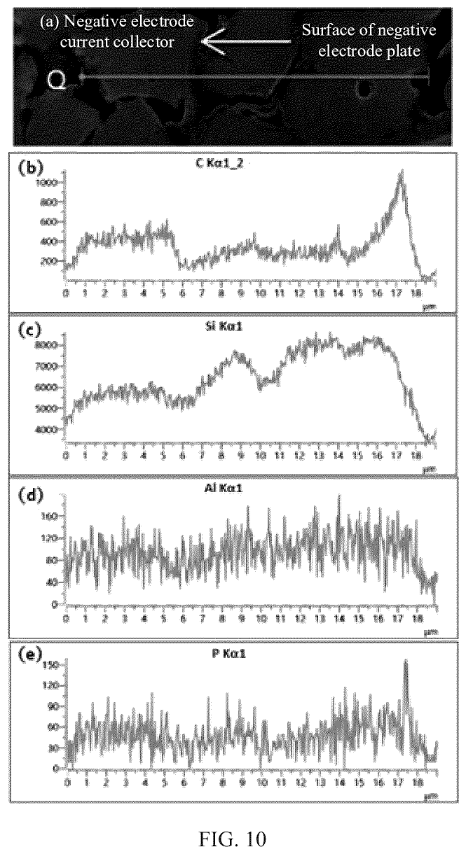

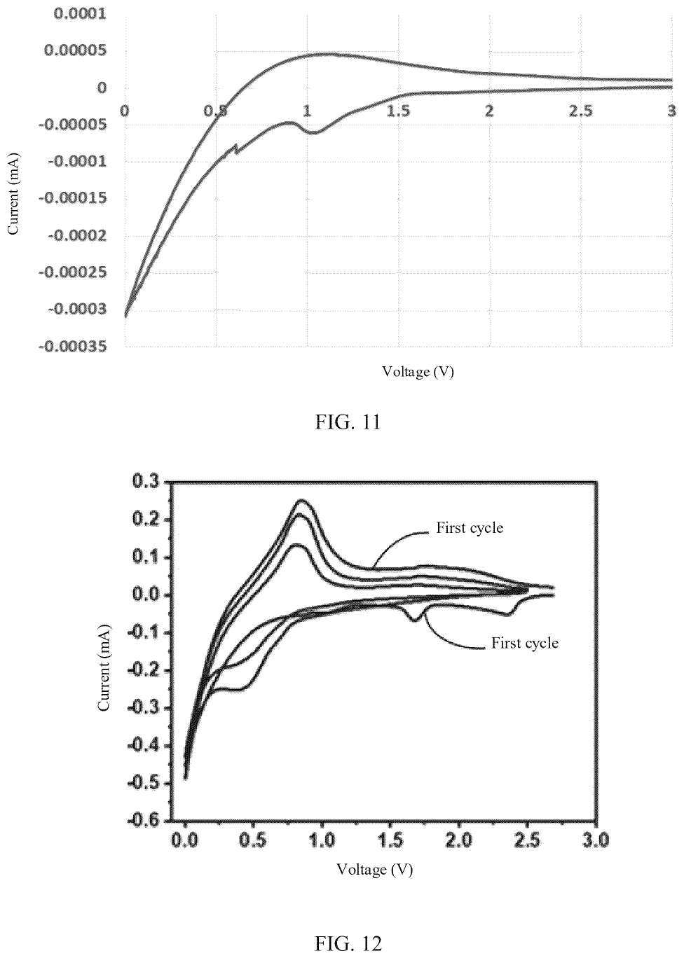

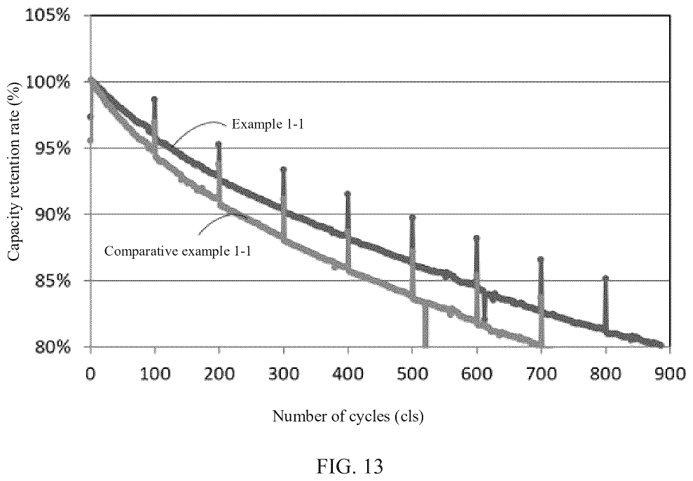

It can be seen from FIG. 2 to FIG. 5 that, as compared with Comparative example 1, the number of small particles in the negative electrode material layer of Example 1-1 is increased. As shown in FIG. 4, the black circles indicate the solid electrolyte material 12, and the solid electrolyte material is distributed on the surface of the particles of the negative electrode active material and is relatively uniform. This indicates that the distribution of the solid electrolyte material in Example 1-1 is relatively uniform in the negative electrode material layer. Further, it can be seen from FIG. 6 to FIG. 9 that elements Si, C, Ti, and Al are present on the surface of the negative electrode active material particles and are relatively uniform in distribution. This indicates that the distribution of the solid electrolyte material in Example 1-1 is relatively uniform in the negative electrode material layer. It can be seen from FIG. 10 that elements C, Si, Al, and P are distributed on line segment Q, and that the dispersion of the solid electrolyte material is relatively uniform in the negative electrode material layer. It can be seen from FIG. 11 that the negative electrode of Example 1-1 has reduction peaks. Further, to highlight the reduction peaks, the preparation method of negative electrode is the same as that of Example 1-1 except that mixing the solid electrolyte material Li_{1.3}Al_{0.3}Ti_{1.7} (PO₄)₃, the mixture of negative electrode active materials artificial graphite and silicon, and polyvinylidene fluoride are mixed at a mass ratio of 80:10:10. A new negative electrode is prepared and tested three times according to the steps of the cyclic voltammetry test to obtain FIG. 12. From FIG. 12, it can be seen that the negative electrode in the first cycle exhibits reduction peaks at 0 V to 0.8 V, 1.5 V to 1.8 V, and 2.3 V to 2.5 V, indicating that the solid electrolyte material undergoes reduction reactions, and that the reduction peaks exhibited by the negative electrode in the second and third cycles are not obvious, indicating that during the cycling, products generated on the surface of the solid electrolyte material are present on the surface of the negative electrode active material, leading to a delay in the reduction of the solid electrolyte material. In addition, for the products generated on the surface of the solid electrolyte material during cycling, the products on the surface are continuously broken and regenerated as the cycles continues, and this process continues throughout the cycling. It can be seen from FIG. 13 that the lithium-ion battery in Example 1-1 has a capacity retention rate of less than 80% after 888 cycles while the lithium-ion battery in Comparative example 1 already has a capacity retention rate of less than 80% after 702 cycles. This indicates that the lithium-ion battery in the examples of this application has better cycling performance.

The mass percentage Y of the solid electrolyte material usually affects the rate performance, lithium precipitation performance, and cycling performance of the lithium-ion battery. It can be seen from Example 1-1 and Examples 1-8 to 1-13 that when the mass percentage Y of the solid electrolyte material is within the range in this application, the ionic conductivity of the negative electrode is high, the resistance per unit area of the negative electrode is low, the discharge capacity retention rate at 3 C is high, the number of cycles is large, and the lithium precipitation state is good. This indicates that the lithium-ion battery of this application has good rate performance, lithium precipitation performance, and cycling performance. The discharge capacity retention rate at 3 C and the number of cycles of the lithium-ion battery in Example 1-11 are higher than those in Example 1-1, and the lithium precipitation state is better, but the mass percentage of the solid electrolyte material in Example 1-11 is larger, and the mass percentage of the negative electrode active materials is smaller, resulting in a lower energy density of the lithium-ion battery.

The composition of the solid electrolyte material usually affects the rate performance, lithium precipitation performance, and cycling performance of the lithium-ion battery. It can be seen from Example 1-1 and Examples 1-14 to 1-16 that when the composition of the solid electrolyte material is within the range in this application, the ionic conductivity of the negative electrode is high, the resistance per unit area of the negative electrode is low, the discharge capacity retention rate at 3 C is high, the number of cycles is large, and the lithium precipitation state is good. This indicates that the lithium-ion battery of this application has good rate performance, lithium precipitation performance, and cycling performance.

Multiple identical lithium-ion batteries were prepared according to the preparation steps of Example 1-1 and tested in the test for mass percentages of Li₂O, Li_{0.5} TiO₂, Li₃P, and Li₃PO₄ after 1000 and 2000 cycles respectively. The test results are shown in Table 3. Multiple identical lithium-ion batteries were prepared according to the preparation steps of Example 1-11 and tested in the test for mass percentages of Li₂O, Li_{0.5}TiO₂, Li₃P, and Li₃PO₄ after 1000 and 2000 cycles respectively. The test results are shown in Table 3.

TABLE 3

| | Num- | Presence | Presence | | | | | |
|---|---|---|---|---|---|---|---|---|
| | ber | of | of | | | | | |
| | of | first | second | | | | | |
| | cycles | charac- | charac- | | | | | |
| Base | in test | teristic | teristic | | D | E | F | G |
| example | (cls) | peak? | peak? | a/b | (%) | (%) | (%) | (%) |
| Example | 500 | Yes | Yes | 1567 | 0.16 | 0.21 | 0.08 | 0.15 |
| 1-1 | 1000 | Yes | Yes | 4763 | 0.185 | 0.38 | 0.143 | 0.23 |
| | 2000 | Yes | Yes | 52367 | 0.223 | 0.43 | 0.155 | 0.29 |
| Example | 500 | Yes | Yes | 2198 | 0.55 | 1.12 | 0.46 | 1.11 |
| 1-13 | 1000 | Yes | Yes | 5342 | 1.02 | 1.87 | 0.63 | 1.38 |
| | 2000 | Yes | Yes | 64732 | 1.23 | 1.97 | 0.74 | 1.54 |

It can be seen from Table 3 that when the number of cycles in test is within the range in this application, the negative electrode material layer exhibits characteristic peaks at binding energies from 455 eV to 468 eV, corresponding to the first characteristic peak and the second characteristic peak, and the ratio a/b of the peak area a of the first characteristic peak and the peak area b of the second characteristic peak is within the range in this application.

TABLE 4

| | | Thick- | | | | | | | | |
|---|---|---|---|---|---|---|---|---|---|---|
| | | ness | | | | | | Discharge | | |
| | Negative | of | Average | | | | | capacity | Number | |
| | electrode | carbon | particle | | | | | retention | of | Lithium |
| | active | material | size | Φ | CW | κ | R | rate at | cycles | precipitation |
| | material | (nm) | (μm) | (%) | (g/cm²) | (S/cm) | (Ω/cm²) | 3C (%) | (cls) | state |
| Exam- | Artificial | / | 10 | 25 | 8 | 3.4 × 10⁻⁴ | 0.118 | 93.2 | 888 | No |
| ple 1- | graphite + | | | | | | | | | lithium |
| 1 | silicon | | | | | | | | | precipitation |
| | (mass ratio | | | | | | | | | |
| | of 1:1) | | | | | | | | | |
| Exam- | Artificial | 1 | 10 | 25 | 8 | 3.42 × 10⁻⁴ | 0.111 | 93.8 | 894 | No |
| ple 2- | graphite + | | | | | | | | | lithium |
| 1 | silicon | | | | | | | | | precipitation |
| | (mass ratio | | | | | | | | | |
| | of 1:1) | | | | | | | | | |
| Exam- | Artificial | 20 | 10 | 25 | 8 | 3.48 × 10⁻⁴ | 0.101 | 93.9 | 895 | No |
| ple 2- | graphite + | | | | | | | | | lithium |
| 2 | silicon | | | | | | | | | precipitation |
| | (mass ratio | | | | | | | | | |
| | of 1:1) | | | | | | | | | |
| Exam- | Artificial | 50 | 10 | 25 | 8 | 3.42 × 10⁻⁴ | 0.096 | 93.4 | 896 | No |
| ple 2- | graphite + | | | | | | | | | lithium |
| 3 | silicon | | | | | | | | | precipitation |
| | (mass ratio | | | | | | | | | |
| | of 1:1) | | | | | | | | | |
| Exam- | Artificial | 60 | 10 | 25 | 8 | 3.32 × 10⁻⁴ | 0.090 | 92.6 | 856 | Slight |
| ple 2- | graphite + | | | | | | | | | lithium |
| 4 | silicon | | | | | | | | | precipitation |
| | (mass ratio | | | | | | | | | at |
| | of 1:1) | | | | | | | | | head |
| Exam- | Artificial | / | 5 | 25 | 8 | 3.28 × 10⁻⁴ | 0.112 | 93.4 | 893 | No |
| ple 2- | graphite + | | | | | | | | | lithium |
| 5 | silicon | | | | | | | | | precipitation |
| | (mass ratio | | | | | | | | | |
| | of 1:1) | | | | | | | | | |
| Exam- | Artificial | / | 25 | 25 | 8 | 3.42 × 10⁻⁴ | 0.121 | 93 | 881 | No |
| ple 2- | graphite + | | | | | | | | | lithium |
| 6 | silicon | | | | | | | | | precipitation |
| | (mass ratio | | | | | | | | | |
| | of 1:1) | | | | | | | | | |
| Exam- | Artificial | / | 28 | 25 | 8 | 3.52 × 10⁻⁴ | 0.126 | 92.8 | 865 | Slight |
| ple 2- | graphite + | | | | | | | | | lithium |
| 7 | silicon | | | | | | | | | precipitation |
| | (mass ratio | | | | | | | | | at |
| | of 1:1) | | | | | | | | | head |
| Exam- | Artificial | / | 10 | 18 | 8 | 3.21 × 10⁻⁴ | 0.104 | 93.5 | 896 | No |
| ple 2- | graphite + | | | | | | | | | lithium |
| 8 | silicon | | | | | | | | | precipitation |
| | (mass ratio | | | | | | | | | |
| | of 1:1) | | | | | | | | | |
| Exam- | Artificial | / | 10 | 35 | 8 | 3.72 × 10⁻⁴ | 0.130 | 92.9 | 879 | No |
| ple 2- | graphite + | | | | | | | | | lithium |
| 9 | silicon | | | | | | | | | precipitation |
| | (mass ratio | | | | | | | | | |
| | of 1:1) | | | | | | | | | |
| Exam- | Artificial | / | 10 | 25 | 5 | 3.88 × 10⁻⁴ | 0.118 | 94.3 | 990 | No |
| ple 2- | graphite + | | | | | | | | | lithium |
| 10 | silicon | | | | | | | | | precipitation |
| | (mass ratio | | | | | | | | | |
| | of 1:1) | | | | | | | | | |
| Exam- | Artificial | / | 10 | 25 | 50 | 3.21 × 10⁻⁴ | 0.119 | 92.1 | 812 | Slight |
| ple 2- | graphite + | | | | | | | | | lithium |
| 11 | silicon | | | | | | | | | precipitation |
| | (mass ratio | | | | | | | | | at |
| | of 1:1) | | | | | | | | | head |
| Exam- | Artificial | / | 10 | 25 | 3 | 3.90 × 10⁻⁴ | 0.117 | 94.9 | 997 | No |
| ple 2- | graphite + | | | | | | | | | lithium |
| 12 | silicon | | | | | | | | | precipitation |
| | (mass ratio | | | | | | | | | |
| | of 1:1) | | | | | | | | | |
| Exam- | Artificial | / | 10 | 25 | 55 | 3.14 × 10⁻⁴ | 0.123 | 91.5 | 734 | Slight |
| ple 2- | graphite + | | | | | | | | | lithium |
| 13 | silicon | | | | | | | | | precipitation |
| | (mass ratio | | | | | | | | | at |
| | of 1:1) | | | | | | | | | head |
| Exam- | Artificial | | 10 | 25 | 8 | 3.67 × 10⁻⁴ | 0.093 | 94.2 | 1067 | No |
| ple 2- | graphite | | | | | | | | | lithium |
| 14 | | | | | | | | | | precipitation |
| Exam- | Hard | | 10 | 25 | 8 | 3.52 × 10⁻⁴ | 0.088 | 94.4 | 869 | No |
| ple 2- | carbon | | | | | | | | | lithium |
| 15 | | | | | | | | | | precipitation |

Note:
“/” in Table 4 means that a related preparation parameter does not exist.

The thickness of the carbon material usually affects the rate performance, lithium precipitation performance, and cycling performance of the lithium-ion battery. It can be seen from Example 1-1 and Examples 2-1 to 2-4 that when the thickness of the carbon material is within the range in this application, the ionic conductivity of the negative electrode is high, the resistance per unit area of the negative electrode is low, the discharge capacity retention rate at 3 C is high, the number of cycles is large, and the lithium precipitation state is good. This indicates that the lithium-ion battery of this application has good rate performance, lithium precipitation performance, and cycling performance.

The average particle size of the negative electrode active materials usually affects the rate performance, lithium precipitation performance, and cycling performance of the lithium-ion battery. It can be seen from Example 1-1 and Examples 2-5 to 2-7 that when the average particle size of the negative electrode active materials is within the range in this application, the ionic conductivity of the negative electrode is high, the resistance per unit area of the negative electrode is low, the discharge capacity retention rate at 3 C is high, the number of cycles is large, and the lithium precipitation state is good. This indicates that the lithium-ion battery of this application has good rate performance, lithium precipitation performance, and cycling performance.

The porosity φ of the negative electrode material layer usually affects the rate performance, lithium precipitation performance, and cycling performance of the lithium-ion battery. It can be seen from Example 1-1 and Examples 2-8 and 2-9 that when the porosity φ of the negative electrode material layer is within the range in this application, the ionic conductivity of the negative electrode is high, the resistance per unit area of the negative electrode is low, the discharge capacity retention rate at 3 C is high, the number of cycles is large, and the lithium precipitation state is good. This indicates that the lithium-ion battery of this application has good rate performance, lithium precipitation performance, and cycling performance.

The coating weight CW of the negative electrode material layer usually affects the rate performance, lithium precipitation performance, and cycling performance of the lithium-ion battery. It can be seen from Example 1-1 and Examples 2-10 to 2-13 that when the coating weight CW of the negative electrode material layer is within the range in this application, the ionic conductivity of the negative electrode is high, the resistance per unit area of the negative electrode is low, the discharge capacity retention rate at 3 C is high, the number of cycles is large, and the lithium precipitation situation is good. This indicates that the lithium-ion battery of this application has good rate performance, lithium precipitation performance, and cycling performance. In Example 2-12, the 3 C discharge capacity retention rate and the number of cycles of the lithium-ion battery are higher than those in Example 2-10 and Example 2-11, and the lithium precipitation situation is better than that in Example 2-11, but the coating weight CW of the negative electrode material layer is too small, resulting in a lower energy density of the lithium-ion battery, which is not suitable for industrial applications. The lithium-ion battery in Example 2-13 has a high discharge capacity retention rate at 3 C and good lithium precipitation state, but the coating weight CW of the negative electrode material layer is too large, so that the infiltration of the electrolyte solution within the negative electrode is limited to some extent during cycling, resulting in a lower number of cycles of the lithium-ion battery.

The type of the negative electrode active materials usually affects the rate performance, lithium precipitation performance, and cycling performance of the lithium-ion battery. It can be seen from Example 1-1 and Examples 2-14 and 2-15 that when the type of the negative electrode active materials is within the range in this application, the ionic conductivity of the negative electrode is high, the resistance per unit area of the negative electrode is low, the discharge capacity retention rate at 3 C is high, the number of cycles is large, and the lithium precipitation state is good. This indicates that the lithium-ion battery of this application has good rate performance, lithium precipitation performance, and cycling performance.

TABLE 5

| | Type and | | | Dis- | | |
|---|---|---|---|---|---|---|
| | percentage | | | charge | Num- | |
| | of | | | capacity | ber | |
| | double | | R | retention | of | Lithium |
| | bond | | (Ω/ | rate at | cycles | precipitation |
| | compound | κ (S/cm) | cm²) | 3C (%) | (cls) | state |
| Example | 44% | 3.4 × 10⁻⁴ | 0.118 | 93.2 | 888 | No lithium |
| 1-1 | EC + 10% | | | | | precipitation |
| | FEC | | | | | |
| Example | 0.5% | 3.2 ×× 10⁻⁴ | 0.122 | 93.0 | 853 | Slight lithium |
| 3-1 | EC + 0.5% | | | | | precipitation |
| | FEC | | | | | at head |
| Example | 65% | 3.46 × 10⁻⁴ | 0.129 | 93.4 | 885 | No lithium |
| 3-2 | EC + 10% | | | | | precipitation |
| | FEC | | | | | |
| Example | 30% | 3.42 × 10⁻⁴ | 0.118 | 93.3 | 889 | No lithium |
| 3-3 | EC + 10% | | | | | precipitation |
| | FEC | | | | | |
| Example | 44% | 3.48 × 10⁻⁴ | 0.120 | 93.5 | 886 | No lithium |
| 3-4 | PC + 10% | | | | | precipitation |
| | VC | | | | | |
| Example | 15% EC | 3.41 × 10⁻⁴ | 0.119 | 92.9 | 863 | No lithium |
| 3-5 | | | | | | precipitation |
| Example | 77% EC | 3.53 × 10⁻⁴ | 0.121 | 93.2 | 88 | Slight lithium |
| 3-6 | | | | | | precipitation |
| | | | | | | at head |
| Example | 12% EC | 3.39 × 10⁻⁴ | 0.119 | 92.1 | 858 | No lithium |
| 3-7 | | | | | | precipitation |
| Example | 1.5% FEC | 3.51 × 10⁻⁴ | 0.120 | 92.1 | 789 | No lithium |
| 3-8 | | | | | | precipitation |
| Example | 12.5% FEC | 3.54 × 10⁻⁴ | 0.119 | 93.4 | 889 | No lithium |
| 3-9 | | | | | | precipitation |
| Example | 15% FEC | 3.55 × 10⁻⁴ | 0.122 | 92.7 | 842 | Slight lithium |
| 3-10 | | | | | | precipitation |
| | | | | | | at head |
| Example | / | 3.3 × 10⁻⁴ | 0.124 | 92.8 | 806 | Slight lithium |
| 3-11 | | | | | | precipitation |
| | | | | | | at head |

Note:
“/” in Table 5 means that a related preparation parameter does not exist. In Example 1-1, 44% EC + 10% FEC means that based on the mass of the electrolyte solution, the mass percentage of EC is 10%, and the mass percentage of FEC is 90%. Other examples and comparative examples should be inferred similarly.

The type and mass percentage of the double bond compound in the electrolyte solution usually affect the rate performance, lithium precipitation performance, and cycling performance of the lithium-ion battery. It can be seen from Example 1-1 and Examples 3-1 to 3-11 that when the type and mass percentage of the double bond compound in the electrolyte solution are within the ranges in this application, the ionic conductivity of the negative electrode is high, the resistance per unit area of the negative electrode is low, the discharge capacity retention rate at 3 C is high, the number of cycles is large, and the lithium precipitation state is good. This indicates that the lithium-ion battery of this application has good rate performance, lithium precipitation performance, and cycling performance.

The type and mass percentage of compound A in the electrolyte solution usually affect the rate performance, lithium precipitation performance, and cycling performance of the lithium-ion battery. It can be seen from Example 1-1 and Examples 3-5 to 3-7 that when the type and mass percentage of compound A in the electrolyte solution are within the ranges in this application, the ionic conductivity of the negative electrode is high, the resistance per unit area of the negative electrode is low, the discharge capacity retention rate at 3 C is high, the number of cycles is large, and the lithium precipitation state is good. This indicates that the lithium-ion battery of this application has good rate performance, lithium precipitation performance, and cycling performance.

The type and mass percentage of compound B in the electrolyte solution usually affect the rate performance, lithium precipitation performance, and cycling performance of the lithium-ion battery. It can be seen from Example 1-1 and Examples 3-8 to 3-10 that when the type and mass percentage of compound B in the electrolyte solution are within the ranges in this application, the ionic conductivity of the negative electrode is high, the resistance per unit area of the negative electrode is low, the discharge capacity retention rate at 3 C is high, the number of cycles is large, and the lithium precipitation state is good. This indicates that the lithium-ion battery of this application has good rate performance, lithium precipitation performance, and cycling performance.

The terms “include”, “comprise”, or any other variants thereof are intended to cover a non-exclusive inclusion, such that a process, method, or article that includes a series of elements includes not only those elements but also other elements that are not expressly listed, or further includes elements inherent to such process, method, or article.

Some embodiments in this specification are described in a related manner. For a part that is the same or similar between these embodiments, reference may be made between these embodiments. Each embodiment focuses on differences from other embodiments.

The foregoing descriptions are merely preferred embodiments of this application, and are not intended to limit this application. Any modifications, equivalent replacements, improvements, and the like made without departing from the spirit and principle of this application shall fall within the protection scope of this application.

What is claimed is:

1. A secondary battery, comprising a positive electrode, a negative electrode, and an electrolyte solution; wherein the negative electrode comprises a negative electrode material layer, the negative electrode material layer comprises a negative electrode active material and a solid electrolyte material; the solid electrolyte material contains aluminum, titanium, phosphorus;
after N charge-discharge cycles of the secondary battery at an ambient temperature of 25° C., the negative electrode material layer comprises Li₂O, Li_{0.5}TiO₂, Li₃P, and Li₃PO₄, wherein 10≤N≤2000; and each of the N charge-discharge cycles consists of charging to 4.45 V at a constant current of 0.02 C, then charging to 0.025 C at a constant voltage of 4.45 V, then leaving standing for 5 minutes, and then discharging to 3.0 V at 0.5 C; and
based on a mass of the negative electrode material layer, a mass percentage of Li₂O is 0.006% to 1.25%, a mass percentage of Li_{0.5} TiO₂ is 0.005% to 2%, a mass percentage of Li₃P is 0.003% to 0.8%, and a mass percentage of Li₃PO₄ is 0.006% to 1.6%.

2. The secondary battery according to claim 1, wherein based on the mass of the negative electrode material layer, a mass percentage of the solid electrolyte material is 0.2% to 9.8%.

3. The secondary battery according to claim 2, wherein the mass percentage of the solid electrolyte material is 0.25% to 2.8%.

4. The secondary battery according to claim 1, wherein based on the mass of the negative electrode material layer, a mass percentage of aluminum is 0.004% to 0.22%, and a mass percentage of titanium is 0.04% to 2.5%.

5. The secondary battery according to claim 1, wherein based on the mass of the negative electrode material layer, a mass percentage of phosphorus is 0.05% to 2.8%.

6. The secondary battery according to claim 1, wherein an ionic conductivity of the negative electrode is 1×10⁻⁴ S/cm to 100 S/cm, and a resistance per unit area of the negative electrode is 0.1Ω to 1Ω.

7. The secondary battery according to claim 1, wherein after the N charge-discharge cycles, the negative electrode material layer is tested by X-ray photoelectron spectroscopy, the negative electrode material layer exhibits characteristic peaks at binding energies from 455 eV to 468 eV, and characteristic peaks of 458±2 eV and 464±2 eV are first characteristic peaks.

8. The secondary battery according to claim 7, wherein a characteristic peak of 460±2 eV is a second characteristic peak, a peak area of the first characteristic peaks is a, and a peak area of the second characteristic peak is b, wherein 0<a/b≤10¹⁰, and a value of a/b increases with increase in the value of N.

9. The secondary battery according to claim 1, wherein cyclic voltammetry test is performed on a button cell formed by using metallic lithium as the counter electrode and the negative electrode, with a scan rate of 0.1 mV/s and a voltage range from 0 V to 3 V, and the negative electrode exhibits reduction peaks at 0 V to 0.8 V, 1.5 V to 1.8 V, and 2.3 V to 2.5 V.

10. The secondary battery according to claim 1, wherein the solid electrolyte material comprises Li₁₊ₓAlₓTi₂₋ₓ (PO₄)₃, wherein 0<x≤0.5.

11. The secondary battery according to claim 1, wherein the solid electrolyte material comprises Li₁₊ₓAlₓM_{y}Ti_{2-x-y} (PO₄)₃, wherein 0<x≤0.5, 0<y≤0.8, and M comprises at least one selected from the group consisting of Si, B, Zn, Ge, and Sn.

12. The secondary battery according to claim 1, wherein a surface of a particle of the solid electrolyte material have a carbon material; the carbon material comprises at least one selected from the group consisting of carbon nanotubes, graphene, and porous carbon; and a thickness of the carbon material is 1 nm to 50 nm.

13. The secondary battery according to claim 1, wherein the negative electrode active material comprises at least one selected from the group consisting of graphite, hard carbon, silicon, a silicon-carbon material, and a silicon-oxide material; and an average particle size of the negative electrode active material is 5 μm to 25 μm.

14. The secondary battery according to claim 1, wherein a porosity of the negative electrode material layer is 18% to 35%.

15. The secondary battery according to claim 1, wherein a coating weight of the negative electrode material layer is 5 mg/cm² to 50 mg/cm².

16. The secondary battery according to claim 1, wherein the electrolyte solution comprises a double bond compound; wherein the double bond compound comprises a compound A; wherein the compound A comprises at least one selected from the group consisting of ethylene carbonate and propylene carbonate; and based on a mass of the electrolyte solution, a mass percentage of the compound A is 15% to 80%.

17. The secondary battery according to claim 1, wherein the electrolyte solution comprises a double bond compound; wherein the double bond compound comprises a compound B; wherein the compound B comprises at least one selected from the group consisting of vinylene carbonate and fluoroethylene carbonate; and based on the mass of the electrolyte solution, a mass percentage of the compound B is 1.5% to 12.5%.

18. An electronic apparatus, comprising a secondary battery; wherein the secondary battery comprises a positive electrode, a negative electrode, and an electrolyte solution, wherein the negative electrode comprises a negative electrode material layer, the negative electrode material layer comprises a negative electrode active material and a solid electrolyte material; the solid electrolyte material contains aluminum, titanium, phosphorus;
after N charge-discharge cycles of the secondary battery at an ambient temperature of 25° C., the negative electrode material layer comprises Li₂O, Li_{0.5}TiO₂, Li₃P, and Li₃PO₄, wherein 10≤N≤2000; and each of the N charge-discharge cycles consists of charging to 4.45 V at a constant current of 0.02 C, then charging to 0.025 C at a constant voltage of 4.45 V, then leaving standing for 5 minutes, and then discharging to 3.0 V at 0.5 C; and
based on a mass of the negative electrode material layer, a mass percentage of Li₂O is 0.006% to 1.25%, a mass percentage of Li_{0.5}TiO₂ is 0.005% to 2%, a mass percentage of Li₃P is 0.003% to 0.8%, and a mass percentage of Li₃PO₄ is 0.006% to 1.6%.

19. An electronic apparatus according to claim 18, wherein the electrolyte solution comprises a double bond compound, wherein the double bond compound comprises a compound A; wherein the compound A comprises at least one selected from the group consisting of ethylene carbonate and propylene carbonate; and based on a mass of the electrolyte solution, a mass percentage of the compound A is 15% to 80%.

20. An electronic apparatus according to claim 18, wherein the electrolyte solution comprises a double bond compound, wherein the double bond compound comprises a compound B; wherein the compound B comprises at least one selected from the group consisting of vinylene carbonate and fluoroethylene carbonate; and based on the mass of the electrolyte solution, a mass percentage of the compound B is 1.5% to 12.5%.
